(19) United States
(12) Patent Application Publication
(10) Pub. No.: US 2025/0341976 A1
(43) Pub. Date: Nov. 6, 2025

(54) NOISE REDUCTION FOR MIXED IN-MEMORY COMPUTING

(71) Applicant: OmniVision Technologies, Inc., Santa Clara, CA (US)

(72) Inventor: Daisuke Saito, Santa Clara, CA (US)

(21) Appl. No.: 18/988,611

(22) Filed: Dec. 19, 2024

Related U.S. Application Data
(60) Provisional application No. 63/642,511, filed on May 3, 2024.
(60) Provisional application No. 63/642,533, filed on May 3, 2024.

(51) Int. Cl. G06F 3/06

(52) U.S. Cl. CPC G06F 3/0625; G06F 3/0659; G06F 3/0673

(57) ABSTRACT

A mixed analog/digital in-memory computing device implements matrix vector multiplication with reduced noise for use by a deep neural network (DNN). For each row of a cross-bar array a multiplier is split into at least a most significant (MS) portion and a least significant (LS) portion and preloaded into at least two cells on one row and at least two different columns of the cross-bar array. An input activation (IA) value is driven onto input conductors of each row and an analog-to-digital converter (ADC) converts output signals from the two columns as a truncated MS partial sum and a truncated LS partial sum. A gain is applied to the truncated MS partial sum and added to the truncated LS partial sum to form a resulting value for one node of the DNN.

### RELATED APPLICATIONS

This application claims priority to U.S. Provisional Patent Application Ser. No. 63/642,511, titled “Noise Reduction for Mixed In-Memory Computing”, filed May 3, 2024, and to U.S. Provisional Patent Application Ser. No. 63/642,533, titled “Noise Reduction for Mixed In-Memory Computing”, filed May 3, 2024, each of which is incorporated herein by reference.

### BACKGROUND

Deep neural networks (DNN) require large amounts of memory, where data is read from the memory, processed, and then stored in the memory. This bottleneck between digital memory and a processing unit is well known for computers using the von Neumann architecture. Over 60% of power and time for a DNN computational problem is spent moving data between the memory and the processing unit-more than the power and time spent processing the data.

In-memory computing is emerging as one way of overcoming this bottleneck, particularly for DNN acceleration. Breaking the memory wall is seen as a way to enable massive computational parallelism for use by DNN. The use of alternative memory devices, such as the memristor, offer further advantages to DNN.

### SUMMARY

The present embodiments include the realization that while analog in-memory computing (AIMC) offers an efficient solution for a first stage of a deep neural networks (DNN), AIMC has a lower signal-to-noise ratio (SNR) as compared to digital solutions. The present embodiments provide mixed analog/digital in-memory computing with improved SNR of AIMC and thereby allow the advantages of AIMC to be realized for use in DNNs.

In certain embodiments, the techniques described herein relate to a mixed analog/digital in-memory computing system with noise reduction, including: a cross-bar array of analog cells for performing matrix vector multiplication, the cross-bar array having a plurality of input conductors for each row of the cross-bar array, and a plurality of output conductors for each column of the cross-bar array; an input peripheral circuit for converting, for each row, an input activation (IA) value into a first IA analog signal driving the input conductor of the row; an analog-to-digital conversion circuit for converting, for each column, an output signal carried by the output conductor of the column to a digital value; a logic operation unit for multiplying, adding, and storing the digital values from the plurality of columns; and control circuitry for controlling operation of the input peripheral circuit, the analog-to-digital conversion circuit, and the logic operation circuit to cause the cross-bar array to perform matrix vector multiplication by splitting the digital multiplier between multiple columns and combining digital values from the multiple columns to form a resulting value with reduced noise.

In certain embodiments, the techniques described herein relate to a noise reduction method for mixed in-memory computing implemented as a cross-bar array of analog cells having a plurality of columns and a plurality of rows, the method including: splitting a digital multiplier into at least a most significant (MS) portion and a least significant (LS) portion, the LS portion being formed of L LS bits of the digital multiplier; for each row of the cross-bar array: preloading an analog cell of a first column using a first analog signal representative of the MS portion; preloading an analog cell of a second column using a second analog signal representative of the LS portion; and driving an input conductor of the row with an analog input signal representing a multi-bit input activation (IA) value for the row; generating an MS output signal from the first column; generating an LS output signal from the second column; and determining a digital resulting value based on the MS output signal and the LS output signal.

In certain embodiments, the techniques described herein relate to a noise reduction method for mixed in-memory computing implemented as a cross-bar array of analog cells having a plurality of columns and a plurality of rows, including: splitting a digital multiplier into at least a most significant (MS) portion and a least significant (LS) portion, the LS portion being formed of L LS bits of the digital multiplier; for each row of the cross-bar array: preloading an analog cell of a first column using a first analog signal representative of the MS portion; preloading an analog cell of a second column using a second analog signal representative of the LS portion; slicing a multi-bit input activation (IA) value for the row into IA bits, where i is a bit position of the IA bit; for each IA bit[i]: driving an input conductor of the row with a first reference voltage when the IA bit is zero and driving the input conductor with a second reference voltage when the IA bit is one; generating an MS output signal from the first column; and generating an LS output signal from the second column; and determining a digital resulting value based on both the MS output signal and the LS output signal for each IA bit[i].

### BRIEF DESCRIPTION OF THE FIGURES

FIG. 1 is a schematic of a prior art computing system implementing the von Neumann architecture to process image data captured by an image sensor.

FIG. 2 is a schematic of one example analog in-memory computation (AIMC) system for processing image data from an image sensor, in embodiments.

FIG. 3 is a schematic illustrating one example deep neural network (DNN) for processing the image data of FIG. 2 to generate an inference, in embodiments.

FIG. 4 is a schematic illustrating one example computational memory that performs matrix vector multiplication, in embodiments.

FIG. 5 is a schematic illustrating one example computational memory implemented in a current-domain technology, in embodiments.

FIG. 6 is a schematic illustrating example DRAM circuits that implement the cells of FIG. 4 in a charge-domain, in embodiments.

FIGS. 7A and 7B illustrate example digital and analog truncation, respectively, of ADC captured values from the output conductors of FIG. 4, in embodiments.

FIG. 8 is a schematic illustrating splitting of a digital weight between two cells of the computational memory of FIG. 4 to increase a bit-width of the computational memory for an eight-bit input activation, in embodiments.

FIG. 9 is a schematic illustrating splitting of a digital weight between two cells of the computational memory of FIG. 4 to increase a bit-width of the computational memory for bit-sliced input activation (IA), in embodiments.

FIG. 10 is a schematic illustrating one example current-domain computational memory with improved noise reduction and increased SQNR, in embodiments.

FIG. 11 is a schematic diagram illustrating example operation of the computational memory of FIG. 10 with noise reduction for multi-bit AI values, in embodiments.

FIG. 12 is a flowchart illustrating one example noise reduction method for mixed in-memory computing, in embodiments.

FIG. 13 is a schematic diagram illustrating example operation of the computational memory of FIG. 10 with noise reduction when IA values are bit-sliced, in embodiments.

FIG. 14 is a flowchart illustrating one example noise reduction method for mixed in-memory computing with IA bit-slicing to input AI, in embodiments.

FIG. 15 shows one example implementation of the computational memory of FIG. 10 with the noise reduction of FIG. 13 when IA values are bit-sliced, where bit truncating, MS shifting, IA-bit shifting, and total summing are performed in the digital domain, in embodiments.

FIG. 16 shows one example implementation of the computational memory of FIG. 10 with the noise reduction of FIG. 13 when IA values are bit-sliced, where bit truncating, MS shifting, and IA-bit shifting are performed in the analog domain, and where total summing is performed in the digital domain, in embodiments.

FIG. 17 shows one example implementation of the computational memory of FIG. 10 with the noise reduction of FIG. 13 when IA values are bit-sliced, where bit truncating, MS shifting, IA-bit shifting, and LS-MS summing are performed in the analog domain, and where total summing is performed in the digital domain, in embodiments.

FIG. 18 shows one example implementation of the computational memory of FIG. 10 with the noise reduction of FIG. 11 when IA values are multi-bit, where bit truncating, MS shifting, and total summing are performed in the digital domain, in embodiments.

FIG. 19 shows one example implementation of the computational memory of FIG. 10 with the noise reduction of FIG. 11 when IA values are multi-bit, where bit truncating and MS shifting are performed in the analog domain, and where total summing is performed in the digital domain, in embodiments.

FIG. 20 shows one example implementation of the computational memory of FIG. 10 with the noise reduction of FIG. 11 when IA values are multi-bit, where bit truncating, MS shifting, and total summing are performed in the analog domain, in embodiments.

FIGS. 21A, 21B, and 21C are schematic diagrams illustrating capture of an input voltage Vᵢ without gain adjustment by the ADCs of FIG. 10, in embodiments.

FIG. 22 is a schematic diagram illustrating an alternative initial acquisition phase of ADC to implement a gain of 1/2, in embodiments.

FIGS. 23A and 23B are schematic diagrams illustrating example stand alone modules that may be switch into circuit by variable analog gain module of FIG. 10 to apply a gain to LS output signals and/or MS output signals of FIGS. 11 and 13, in embodiments.

FIGS. 24A, 24B, and 24C are schematic diagrams illustrating three example circuits for the module of FIG. 23B, in embodiments.

FIG. 25A is a schematic illustrating a conventional amplifier circuit, in embodiments.

FIG. 25B is a schematic illustrating one example R-2R DAC circuit used by the ADC of FIG. 10, in embodiments.

FIGS. 26A, 26B, and 26C are schematic diagrams illustrating example SAR ADCs that may each represent the ADC of FIG. 10, in embodiments.

FIG. 27A is a schematic diagram illustrating example integration of the computational memory of FIG. 4 with an image sensor, in embodiments.

FIG. 27B is a schematic diagram illustrating example functionality between the image sensor and the ASIC die of FIG. 27A, in embodiments.

FIGS. 28 and 29 are schematic diagrams illustrating cooperation between two ADCs to bit-shift and sum two analog values prior to conversion of the total to a digital value, in embodiment.

### DETAILED DESCRIPTION OF THE EMBODIMENTS

Analog in-memory computing (AIMC) is an attractive solution to achieve low power/high efficiency operation with a small on-chip foot print for multiply accumulations, which is a main part of computations used by deep neural networks (DNNs). For example, AIMC implements analog multiply-accumulate cells (MACs) that provide a low-power and high efficiency alternative to digital computing. However, analog MACs have a lower signal-to-noise ratio (SNR) as compared to digital computing because of process, voltage, and temperature (PVT) variation across the analog MACs. Propagation of this noise to subsequent parts of the DNN may impact results and/or performance of the DNN. The present embodiments teach of methods for improving the SNR of AIMC such that the AIMC outputs may be successfully used in the subsequent parts of the DNN.

Although the following examples illustrate the user of AIMC with image sensors, the SNR improvement is not limited to use with image sensors and may be applied to AIMC used in any kinds of embedded AI hardware that uses AIMC.

The following three use-cases are provided as examples. (1) Artificial intelligence (AI) application-specific integrated circuits (ASICs) support common DNN and frameworks by providing hardware accelerated by AIMC. This is relatively high performance area in the edge computing field, and security is a main application. Through use of the disclosed noise reduction for mixed in-memory computing, a high efficiency and higher accuracy computing is achieved. (2) On-sensor real-time computing is used for determining a region of interest (ROI) within an image, where the on-sensor real-time computing generates meta data for the sensed image. On-sensor real-time computing (e.g., on-the-fly computing) is used in augmented reality (AR), virtual reality (VR), and automotive applications for example. Advantageously, the disclosed noise reduction for mixed in-memory computing achieves low-power and higher accuracy computing operation. (3) Always-on low-power AI may be embedded in sensors that operate continuously (e.g., always on). Such embedded sensors are used for event detection in applications including security, doorbells, etc. Advantageously, the disclosed noise reduction for mixed in-memory computing allows AIMC to achieve low-power with higher accuracy computation than with prior, noisier, circuitry.

The traditional von Neumann architecture includes a digital data bus that couples memory with a processing unit, where the processing unit fetches a value from memory, processes that value, and then stores the result back in the memory.

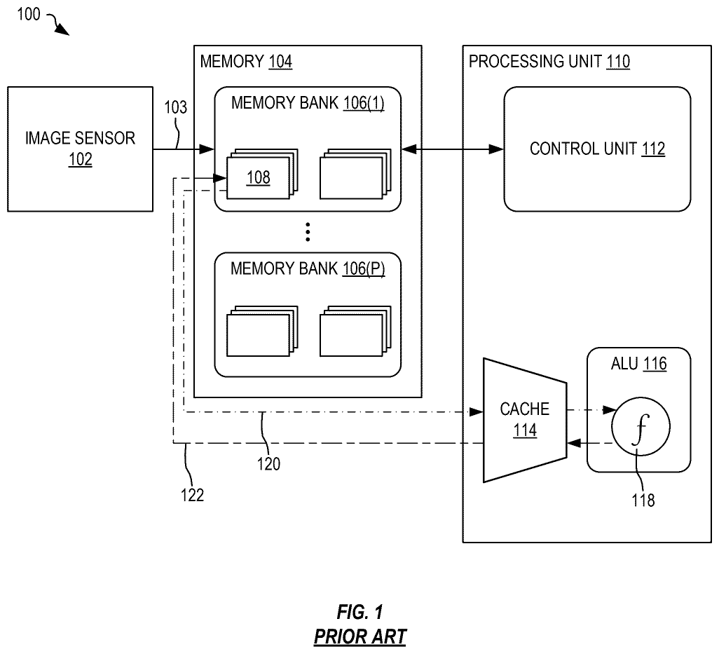

FIG. 1 is a schematic of a prior art computing system 100, implemented using the von Neumann architecture, for processing image data 103 captured by an image sensor 102. Prior art computing system 100 includes a memory 104 with a plurality of memory banks 106(1)-106(P) and a processing unit 110 with a control unit 112, a cache 114, and an arithmetic logic unit (ALU) 116. Image data 103 is received from image sensor 102 and stored in cells 108 of memory bank 106(1). Control unit 112 causes a read 120 to transfer data of cell 108 to ALU 116, via cache 114, where ALU 116 implements a function 118 (e.g., a mathematical operation) on the data. Control unit 112 then causes a write 122 to transfer the resulting data back to cell 108 (or a different cell) of memory 104. In this architecture, function 118 is implemented external to memory 104, and as known in the art, read 120 and write 122 of data from and to memory 104 causes a significant bottleneck for memory intensive computation as required by a DNN.

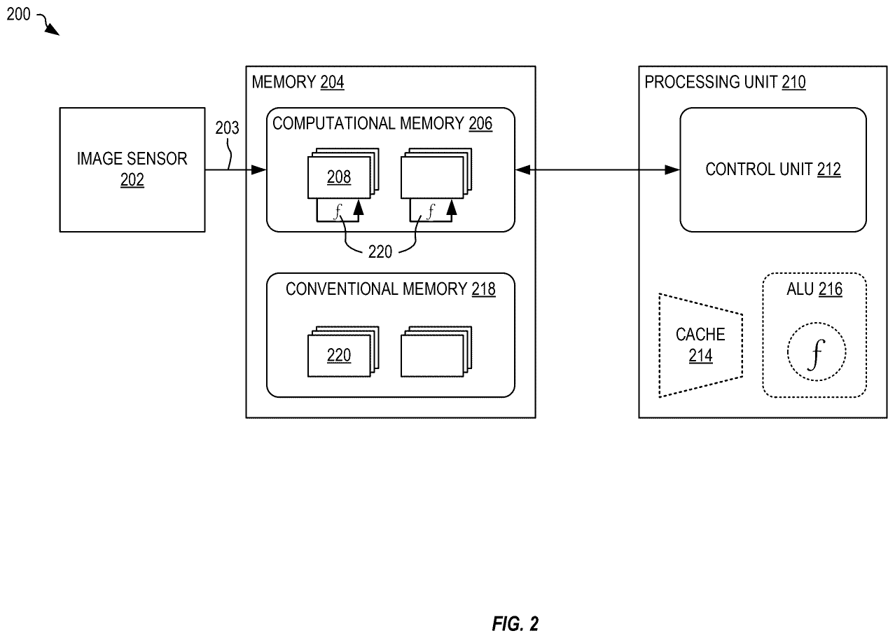

FIG. 2 is a schematic of one example analog in-memory computation (AIMC) system 200 for processing image data 203 from an image sensor 202, in embodiments. AIMC system 200 includes memory 204 with computational memory 206 and a processing unit 210 with a control unit 212, a cache 214, and an ALU 216. Computational memory 206 includes a plurality of cells 208 that are individually programmed to implement function 220 on data input to computational memory 206 as directed by control unit 212. Advantageously, function 220 is applied to data of cells 208 within computational memory 206 concurrently and without the need to move the data between memory 204 and processing unit 210. By way of example, transfer of data from Dynamic Randon Access Memory (DRAM) consumes over 600 picojoules (pJ) and transfer of data from SRAM consumes approximately 5-50 pJ. In contrast, in-memory computing (IMC) consumes sub-pJ. Accordingly, cache 214 and ALU 216 are not used to implement function 220 in this embodiment.

As shown in FIG. 2, memory 204 may also include conventional memory 218 in a von Neumann configuration where data is moved between conventional memory 218 and processing unit 210 using reads and writes. Accordingly, system 200 implements both AIMC within computational memory 206 and conventional data processing of data in conventional memory 218 using ALU 216.

With the increased demand for artificial intelligence processing, a data and thereby memory intensive type of processing for deep neural networks, the power required by data processing centers increases. Computational memory 206 reduces the power requirement by implementing function 220 in-memory and thereby avoiding repeated movement of data (e.g., read 120 and write 122 of FIG. 1) between memory 204 and a separate processing unit 210. Computational memory 206 provides fast, low-power computing with a small footprint that allows on-chip integration.

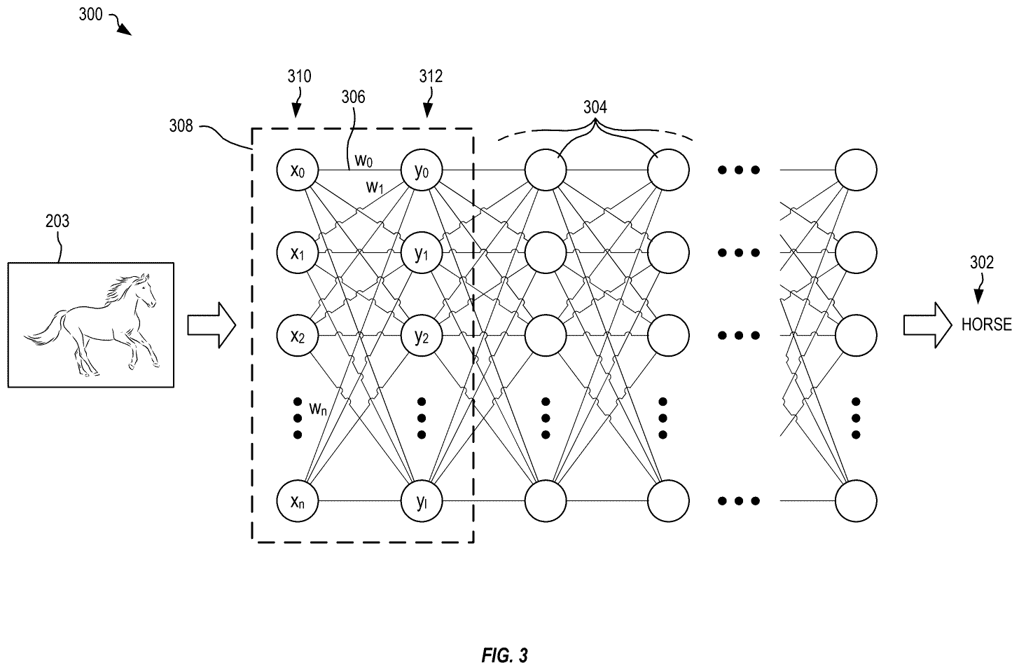

FIG. 3 is a schematic illustrating one example DNN 300 for processing image data 203 of FIG. 2 to generate an inference 302, which in this example indicates whether image data 203 includes an image of a horse. DNN 300 includes a plurality of multiply-accumulate cells (MACs) 304 (shown as circles), where each MAC 304 multiplies inputs from other cells by an associated weight 306 for each other cell, represented as lines between MACs 304, and accumulates the results. Per convention for a first layer 308 of DNN 300, an input array 310 of MACs 304 is referenced as x₀ through xₙ and an output array 312 (e.g., a next column of MACs 304 of DNN 300) is references as y₀ through y₁, where y₀ through y are the input array of a next layer of DNN 300. Weights 306 are referenced as w₀ through wₙ where w₀ represents weight 306 applied to a value received by y₀ from x₀, w₁ represents weight 306 applied to a value received by y₀ from x₁, and so on.

Following this convention, equation (1) illustrates function 220 to calculate y₀.

$${y}_{0} = \vec{x} \cdot {\vec{W}}^{T} = [ {x}_{1} … {x}_{j} … {x}_{n} ] \cdot [ \begin{matrix}{w}_{0} \\ ⋮ \\ {w}_{j} \\ ⋮ \\ {w}_{n}\end{matrix} ] = {\sum }_{j = 0}^{N - 1} {x}_{j} \cdot {w}_{j} \qquad ( 1 )$$

That is, equation (1) only calculates a value for y₀. The number of MACs 304 in each output array 312 for each layer 308 need not be the same as the number of MACs 304 in input array 310. That is, l is not required to equal n in FIG. 3.

### General

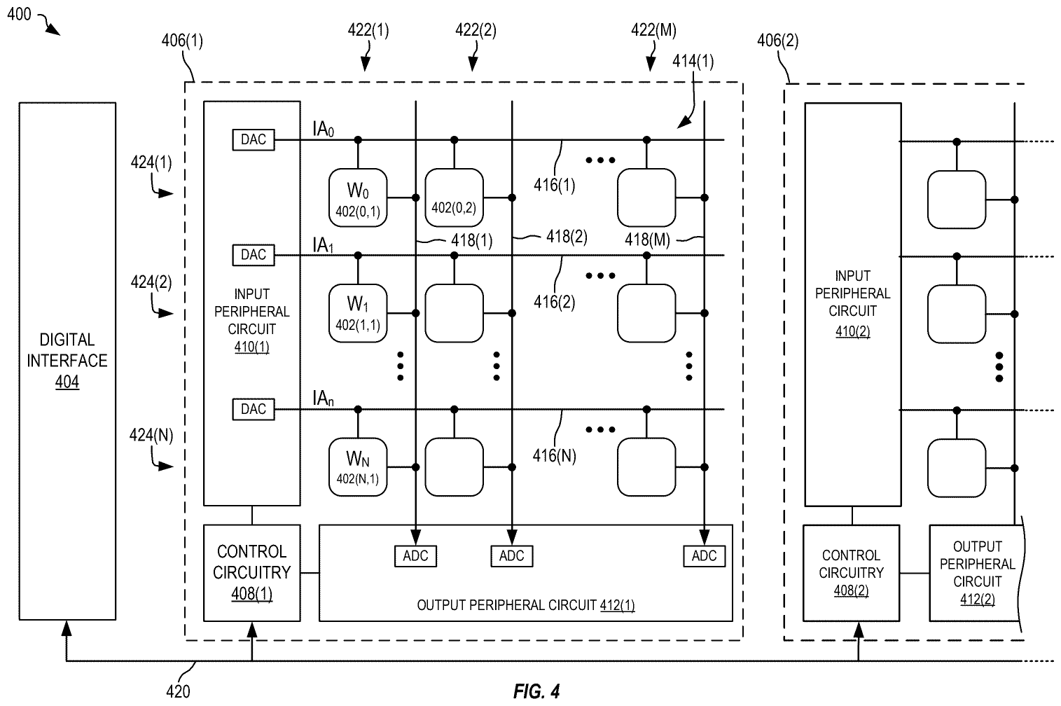

FIG. 4 is a schematic illustrating one example computational memory 400 that performs matrix vector multiplication (MVM), in embodiments. Computational memory 400 may represent computational memory 206 of FIG. 2.

Computational memory 400 includes a digital interface 404 and at least one computational block 406 (e.g., shown with computational block 406(1) and 406(2)), where each computational block 406 includes control circuitry 408 (e.g., control circuitry 408(1) and 408(2)), input peripheral circuits 410 (e.g., input peripheral circuits 410(1) and 410(2) that include input activation (IA) drivers and/or word line (WL) drivers), output peripheral circuits 412 (e.g., output peripheral circuits 412(1) and 412(2)), and a cross-bar array 414 (e.g., cross-bar array 414(1)) connecting a plurality of analog cells 402. Digital interface 404 provides communication, via a digital bus 420, between computational memory 400 and host devices for example. Cross-bar array 414(1) is formed as a grid of non-connecting conductors, that includes a plurality of input conductors 416(1)-416(N) and a plurality of output conductors 418(1)-418(M) such that computational block 406 has M columns (e.g., columns 422(1)-422(M)) and N rows (e.g., rows 424(1)-424(N)). Each cell 402 connects between one input conductor 416 and one output conductor 418, such that exactly one cell 402 connects between any pair of one input conductor 416 and one output conductor 418, as shown.

Control circuitry 408 implements a sequence controller that controls operation of each computational block 406, input peripheral circuits 410, output peripheral circuits 412, and cross-bar array 414 that performs MVM as used by DNN 300 of FIG. 3, for example. Control circuitry 408 controls input peripheral circuits 410 and/or output peripheral circuits 412 to program each cell 402 with a multiplier value, such as weight 306 of DNN 300. As shown in the example of FIG. 4, cell 402(0,1) is programed with weight W₀ and cell 402(1,1) is programed with weight W₁, and so on. The following examples use the digital weights of DNN 300 to represent the digital multipliers of cells 402.

Each cell 402 generates an analog output signal (e.g., current or charge) based on an IA input signal and the preloaded weight and since the output of cells 402 in one column 422 are coupled to one output conductor 418 the output signals (e.g., current or charge) on output conductor 418 are summed on that output conductor 418. The output signal is sensed within output peripheral circuits 412 by an analog-to-digital converter (ADC). The ADC may be implemented as a successive approximation register (SAR) ADC, or by other types of ADC without departing from the scope hereof. In certain embodiments, output peripheral circuits 412 includes one ADC per column. In other embodiments, output peripheral circuits 412 includes fewer ADCs that are multiplexed between multiple columns. Column 422 performs a MAC function represented by equation (2).

$$Q = {\sum }_{j = 0}^{N - 1} ( {V}_{j} \cdot t ) \cdot {G}_{j} \qquad ( 2 )$$

### Current-Domain Technology

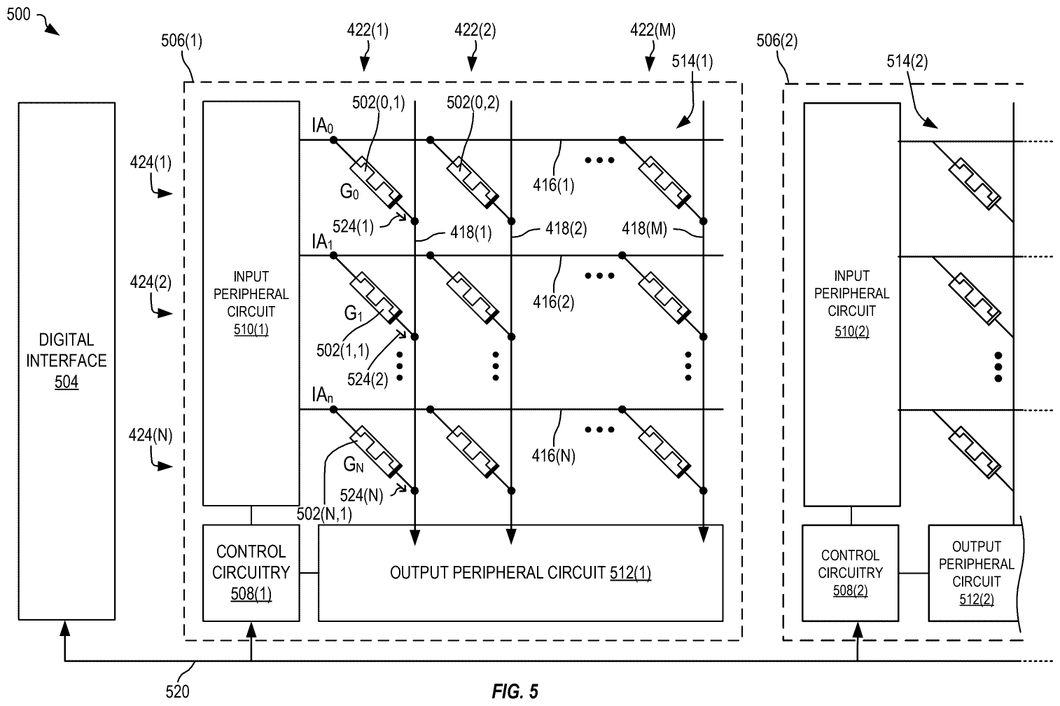

FIG. 5 is a schematic illustrating one example computational memory 500 implemented in a current-domain technology, in embodiments. Computational memory 500 is one example of computational memory 206 of FIG. 2. In this embodiment, each MACs 304 uses a memristor 502 that is preprogrammed with a gain representing a corresponding weight 306 of FIG. 3. However, computational memory 206 may be implemented using other technologies, such as a charge-domain technology that uses DRAM-IMC cells, SRAM, Flash, NVM (RRAM, PCM, STT-MRAM, SOT-MRAM, FeFET) for example.

Computational memory 500 includes a digital interface 504 and at least one computational block 506 (e.g., computational blocks 506(1) and 506(2)). Each computational block 506 includes control circuitry 508 (e.g., control circuitry 508(1) and 508(2)), input peripheral circuits 510 (e.g., input peripheral circuits 510(1) and 510(2)), output peripheral circuits 512 (e.g., output peripheral circuits 512(1) and 512(2)), and a cross-bar array 514 (e.g., cross-bar array 514(1)), formed as a grid of non-connecting conductors, that includes a plurality of input conductors 416(1)-416(N) and a plurality of output conductors 418(1)-418(M). Each one of the plurality of memristors 502 connects between one input conductor 416 and one output conductor 418, such that exactly one memristor 502 connects any pair of one input conductor 416 and one output conductor 418, as shown.

Computational memory 500 includes a communication bus 520 that connects digital interface 504 with control circuitry 508 of each computational block 506. Control circuitry 508 controls operation of input peripheral circuits 510 and output peripheral circuits 512 as describe in further detail below. Control circuitry 508 controls input peripheral circuits 510 and output peripheral circuits 512 to program each memristor 502 with a multiplier value, illustrated as a gain value corresponding to weight 306 of DNN 300. For example, memristor 502(0,1) is programed with gain G, that corresponds to weight w₀, and memristor 502(1,1) is programed with gain G₁ that corresponds to weight W₁, and so on.

In this example, computational block 506(1) implements functionality of first layer 308 of DNN 300 of FIG. 3, where a first column 422(1) of computational block 506(1) implements function 220 to determine a value of a first MAC 304 (e.g., y₀) of output array 312 based on inputs from input array 310 and weights w₀-wₙ. In one example of operation, control circuitry 508(1) controls input peripheral circuits 510(1) to drive input conductor 416(1) with a voltage representing x₀, input conductor 416(2) with a voltage representing x₁, and so on. For example, input peripheral circuits 510 include digital-to-analog converters (DACs) that convert 8-bit input values of input array 310 (e.g., x₀-xₙ) into voltages that drive input conductors 416. Concurrently, memristor 502(0,1) multiplies the voltage on input conductor 416(1) by G₀ to generate a current 524(1) on output conductor 418(1), memristor 502(1,1) multiplies the voltage on input conductor 416(2) by G₁ to generate a current 524(2) on output conductor 418(1), . . . and memristor 502(N,1) multiplies the voltage on input conductor 416(N) by GN to generate a current 524(N) on output conductor 418(1). Other columns of computational block 506 operate similarly to generate output currents on corresponding output conductors 418. Control circuitry 508(1) then controls output peripheral circuits 512(1) to measure the current on output conductor 418(1) that represent a value for output array 312 (e.g., y₀-y₁) of DNN 300. The current measured by output peripheral circuits 512(1) on output conductor 418(1) is the sum of currents 524(1)-(N), such that column 422(1) performs a MAC function. This is represented by equation (3).

$$I = {\sum }_{j = 0}^{N - 1} {V}_{j} \cdot {G}_{j} \qquad ( 3 )$$

### Charge-Domain Technology

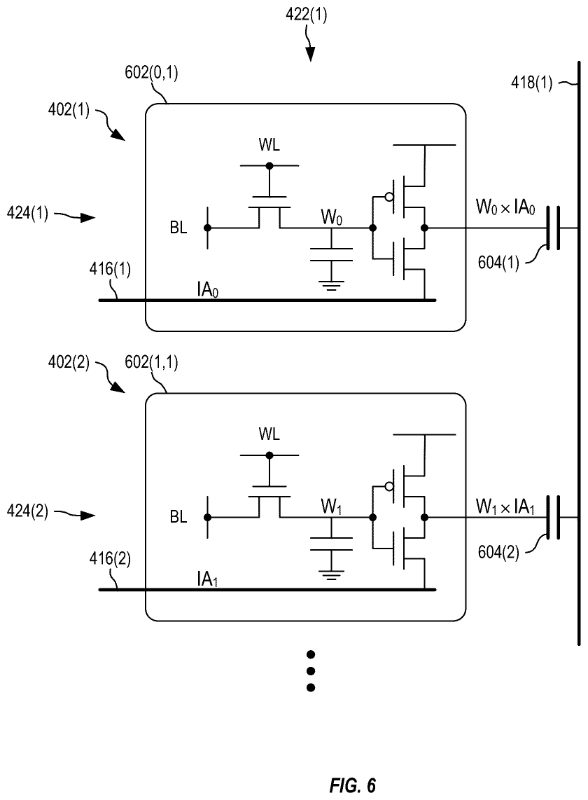

FIG. 6 is a schematic illustrating example DRAM circuits 602 that implement cells 402 of FIG. 4 in a charge-domain, in embodiments. In this embodiment, each cell 402 includes a DRAM circuit 602 and a coupling capacitor 604 (e.g., coupling capacitors 604(1) and 604(2)).

Control circuitry 408 controls input peripheral circuits 410 and/or output peripheral circuits 412 to program each DRAM circuit 602 with a gain value corresponding to one weight 306 of DNN 300. For example, DRAM circuit 602(0,1) is programed with gain G₀ that corresponds to weight w₀, and DRAM circuit 602(1,1) is programed with gain G₁ that corresponds to weight W₁, and so on.

In one example of operation, DRAM circuit 602 generates an output charge that represents IA (e.g., an input current representative of an input value) multiplied by the stored weight 306. The output charge is coupled to one output conductor 418 via coupling capacitor 604 such that the charge on one output conductor 418 is a sum of charges generated by cells 402 coupled to that output conductor 418. Accordingly, the column 422(1) performs a MAC function. This is represented by equation (4).

$$Q = {\sum }_{j = 0}^{N - 1} ( {V}_{j} \cdot t ) \cdot {G}_{j} \qquad ( 4 )$$

As noted above, PVT introduces unwanted variation in analog circuits (e.g., cells 402, input peripheral circuits 410, and output peripheral circuits 412 of computational memory 400) which may be measured as a signal-to-quantization-noise ratio (SQNR). SQNR is conventionally reduced by truncating the least-significant bits of resulting values. However, where each column 422 of computational block 406 represents one MAC 304 of output array 312 of first layer 308, the number of bits each cell 402 effectively stores is already limited, and truncating the least significant bits further reduces the bit width of each cell 402. The reduced accuracy may be insignificant for certain applications of DNN 300 but may be significant for others. Accordingly, it is desirable to improve the SQNR without reducing the effective bit width of the calculations.

### ADC Truncation

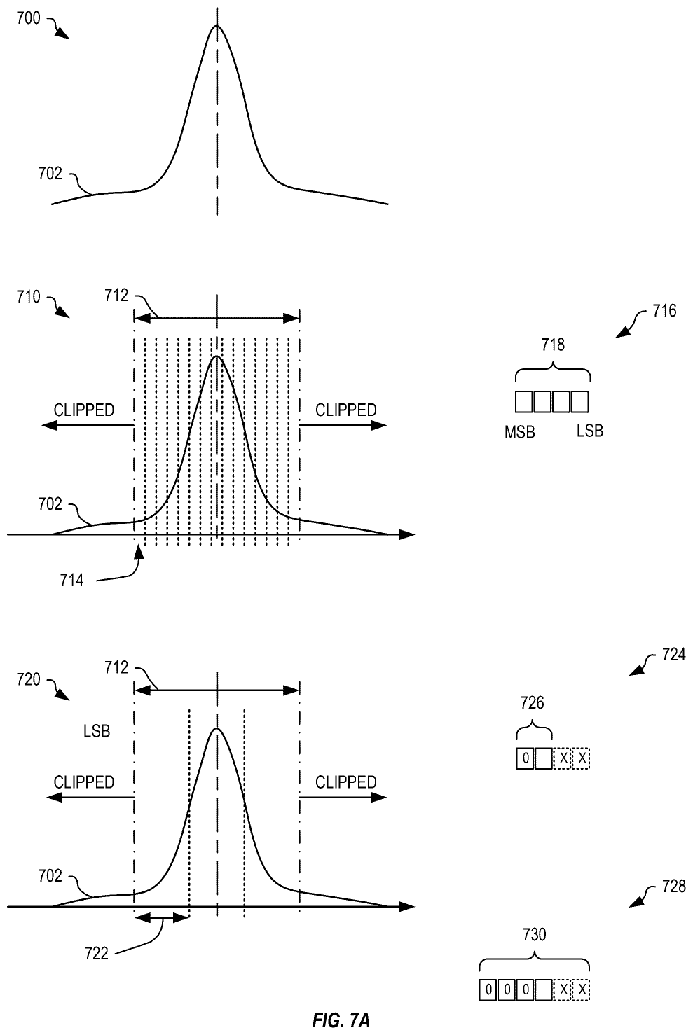

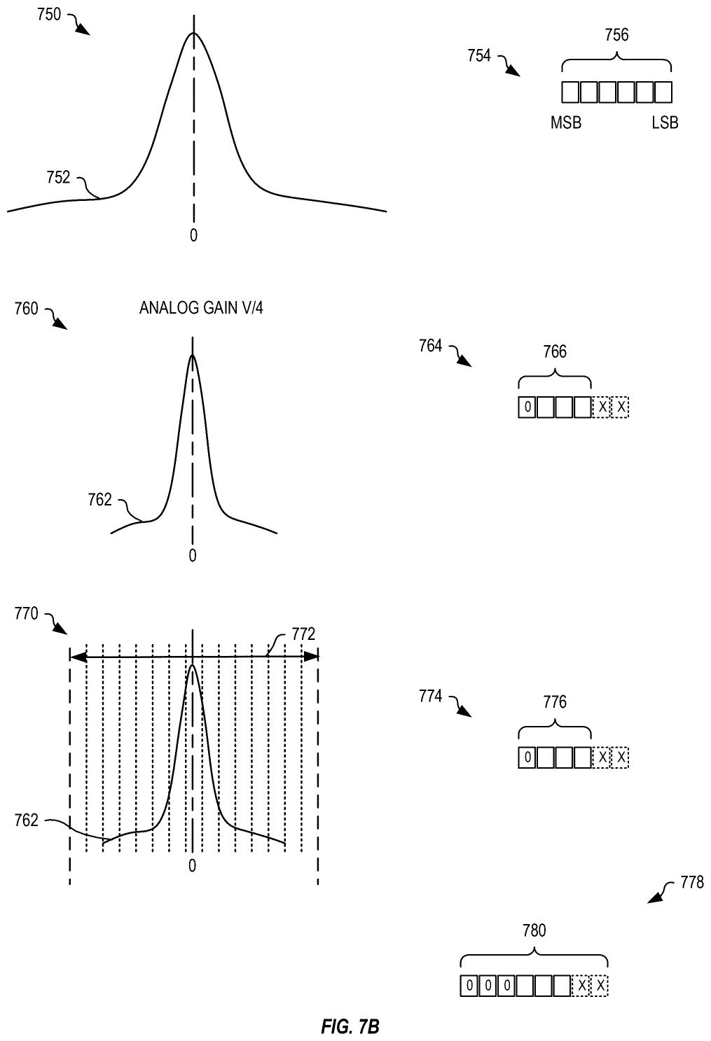

FIGS. 7A and 7B illustrate example digital and analog truncation, respectively, of ADC captured values from output conductors 418 of FIG. 4, in embodiments. For clarity of illustration, a four-bit ADC is illustrated; however, the ADC may have more or fewer bits without departing from the scope hereof.

As noted above, PVT and quantization errors introduce undesirable noise that propagates through DNN 300. Bit precision and range of captured values is controlled by selecting an appropriate ADC conversion range 712 that is tuned according to a distribution curve 702 of output of columns 422 of computational block 406 of FIG. 4 and a desired precision (e.g., four-bits). Quantization noise occurs in the LS bits of a captured value, and reducing this noise by truncation of LS bits improves SQNR. The truncation may be affected in either or both, the analog domain and the digital domain. In the digital domain, the number of bits captured by the ADC may be controlled such that LS bits are not captured and thus reducing noise. In the analog domain, a gain (e.g., V/4) may be applied to the analog signal prior to capture of a value by the ADC. Accordingly, the analog signal is reduced such that the noise is outside the capture range of the ADC.

In the digital level truncation example of FIG. 7A, graph 700 illustrates an example distribution curve 702 of the analog values of output conductors 418. Graph 710 illustrates a capture range 712 of the ADC that is positioned to capture the most important values of distribution curve 702. In this example, the analog signal and capture range 712 are not changed. As shown in graph 710, capture range 712 is divided into fifteen sub-ranges and the ADC captures a value 716 of four bits 718. Accordingly, a LSB of value 716 is defined with a corresponding LSB sub-range 714. Values outside capture range 712 are not captured by the ADC and are clipped.

Graph 720 illustrates distribution curve 702 and the same capture range 712, but where the ADC is controlled to capture a value 724 with only two-bits 726. Accordingly, capture range 712 is divided into three sub-ranges such that the ADC operates with an LSB defined with an LSB sub-range 722, which is four times the width of LSB sub-range 714. In another example, where a bit depth of an ADC is changed from six-bits to four-bits, without changing the capture range V_dr of the ADC, the LSB sub-range changes from V_dr/2⁶ to V_dr/2⁴. Additional bit shifting may be affected in either the digital or analog domain to generate a value 728 with the required number of bits 730.

In the analog level truncation example of FIG. 7B, graph 750 illustrates an example distribution curve 752 of the analog values of output conductors 418. In this example, the output distribution range corresponds to a value 754 that is captured in six bits 756. Graph 760 illustrates a narrowed distribution curve 762 after a gain of V/4 has been applied (e.g., to the analog output of output conductors 418), resulting in a reduced distribution range that, implements analog level truncation, where narrowed distribution curve 762 may be captured as a value 764 that requires four bits 766 as compared to six bits 756 of value 754. Graph 770 shows narrowed distribution curve 762 is within a capture range 772 of a four-bit ADC, such that narrowed distribution curve 762 is captured as ADC captured information 774 with four-bits 776, effectively truncating the two LS-bits.

This solution is particularly useful when the analog signal on output conductor 418 is greater than capture range 772 of the ADC. By applying a gain to reduce distribution curve 752 to narrowed distribution curve 762, important parts of the analog signal are shifted to be within capture range 772 and are therefore captured by the ADCs. Accordingly, information of the analog signal is effectively truncated.

### Weight Slicing

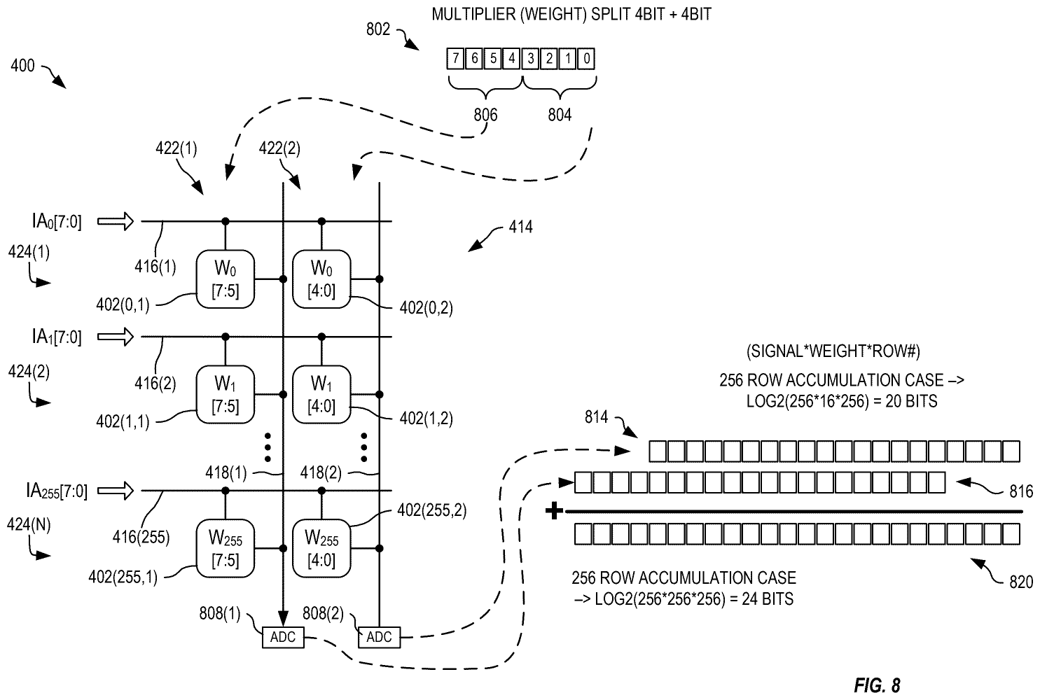

FIG. 8 is a schematic illustrating splitting of a digital weight 802 between two cells of computational memory 400 to increase a bit-width of computational memory 400 for an eight-bit input activation, in embodiments. Splitting of digital weight 802 over two (or more) columns 422 of computational memory 400 reduces the number of levels required in each cell to store the digital weight. Further, by using two columns 422 for each weight, the number of levels available to store the weight is increased, and thus the resolution of computational memory 400 is increased. For example, where the implementation of cell 402 has a storage resolution of four bits (e.g., stores only sixteen distinct levels), using two cells for each multiplication allows for an eight-bit resolution.

Digital weight 802 (e.g., weight W₀) has T bits that are divided into a low nibble 804 having L LS bits and a high nibble 806 having H MS bits (e.g., T−L−the remaining bits of digital weight 802). In the example of FIG. 8, digital weight 802 has eight bits (e.g., T=8), and each of low nibble 804 and high nibble 806 has four bits (e.g., L=4 and H=4); however, digital weight 802 may have more or fewer bits without departing from the scope hereof. For example, where digital weight 802 has six bits, each of low nibble 804 and high nibble 806 has three bits. In another example, where digital weight 802 has ten bits, each of low nibble 804 and high nibble 806 has five bits. Further, digital weight 802 may be split into multiple portions (e.g., a greatest-significant (GS) portion, an MS portion, and a LS portion, but may include more portions without departing from the scope hereof), where each portion, represented as an analog signal, is preloaded into a different column 422 of cross-bar array 414. For example, the GS portion represented as an analog signal is preloaded into a third cell of a third column of the cross-bar array of analog cells, and a GS partial sum is captured from a third output conductor of the third column. The GS partial sum is multiplied by 2 raised to the power (L+H), and the MS portion is multiplied by 2 raised to the power L. The LS partial sums, the MS partial sums, and the GS partial sums are added to form the resulting value for one node of DNN 300, for example. In this example, the portions do not overlap.

High nibble 806, represented as an analog signal, is preloaded into cells 402 of column 422(1) and low nibble 804, represented as an analog signal, is preloaded into cells 402 of column 422(2). As appreciated, the order of low and high nibbles and/or columns 422(1) and 422(2) may be swapped without departing from the scope hereof. To calculate the resulting MAC value, a first circuit 808(1) measures a least significant (LS) partial sum 814 of a current on output conductor 418(1) and a second circuit 808(2) measures a most significant (MS) partial sum 816 of a current on output conductor 418(2). LS partial sum 814 and MS partial sum 816, which is first multiplied by 2 raised to the power L (e.g., shifted by L bits), since high nibble 806 was effectively divided by 2^{L} by the split, are then summed (e.g., as digital values in the digital domain) to form a resulting value 820 for y₀. In the example of FIG. 8, since each IA value is eight-bits, each low nibble 804 and high nibble 806 is four-bits, and the number of rows 424(N) is 256, each of LS partial sum 814 and MS partial sum 816 is twenty-bits in length and resulting value 820 is twenty-four-bits in length. This functionality is summarized in equations (5), (6), and (7).

$${y}_{0} = \vec{IA} \cdot {\vec{W}}^{T} = [ {IA}_{8 b \_ 0} … {IA}_{8 b \_ 255} ] \cdot [ \begin{matrix}{W}_{8 b \_ 0} \\ ⋮ \\ {W}_{8 b \_ 255}\end{matrix} ] \qquad ( 5 )$$

$$= {\sum }_{i = 0}^{{2}^{8} - 1} {IA}_{8 b \_ i} \cdot {W}_{8 b \_ i} \qquad ( 6 )$$

$$= {\sum }_{i = 0}^{{2}^{8} - 1} {IA}_{8 b \_i} \cdot {W}_{a \_ 8 b [ 3 : 0 ] \_ i} + {2}^{4} \cdot {\sum }_{i = 0}^{{2}^{8} - 1} {IA}_{8 b \_ i} \cdot {W}_{b\_ 8 b [ 7 : 4 ] \_ i} \qquad ( 7 )$$

Although this solution improves resolution, it may also decrease SQNR, since noise from operation of column 422(1), which manifests in the least significant few bits of MS partial sum 816, is multiplied by 2^{L} (e.g., shifted by L bits) prior to being added with LS partial sum 814 to form resulting value 820. Thus, the noise from operation of column 422(1) may propagate to subsequent layers of DNN 300. As noted above, digital weight may be divided into multiple portions, and multiple partial sums are generated and added to form the resulting value.

Weight Slicing with Input Bit Slicing

The following example illustrates inputting of digital IA values one bit at a time. However, digital IA values may be sliced into fewer portions, where each portion has multiple bits. For example, IA values may be split into nibbles and processed in two cycles of computation al memory 400.

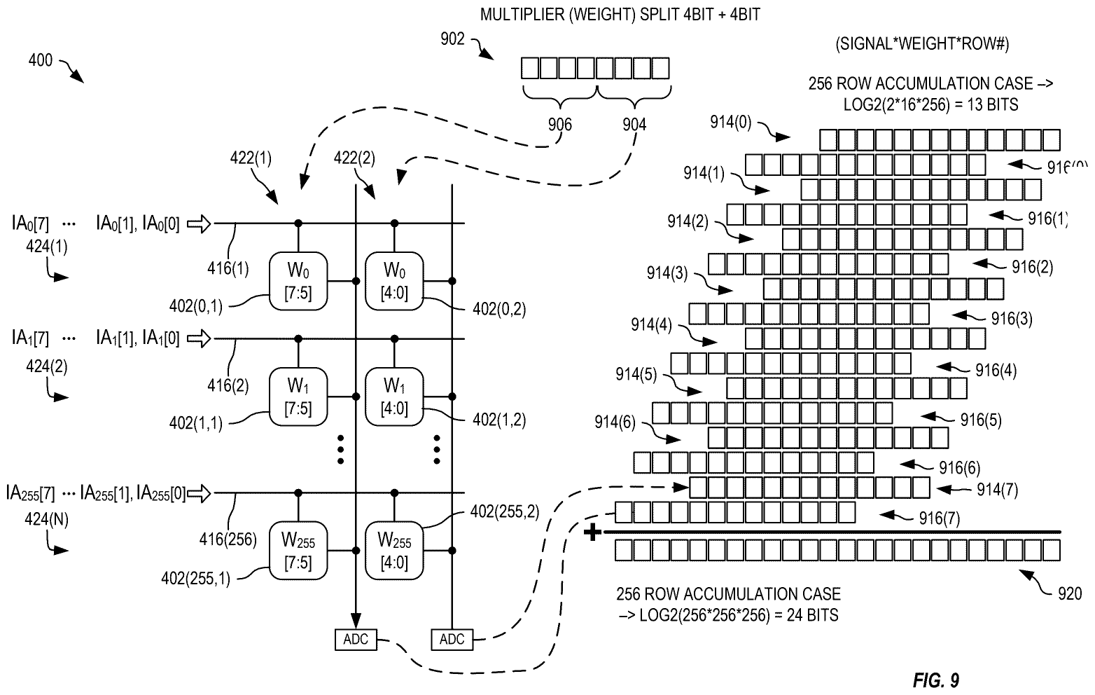

FIG. 9 is a schematic illustrating splitting of a digital weight 902 between two cells of computational memory 400 to increase a bit-width of computational memory 400 for bit-sliced input activation, in embodiments. In the example of FIG. 9, each digital IA value has eight bits (e.g., P=8). For input bit-slicing, each bit of a digital IA (e.g., each bit of one of IA₀-IA₂₅₅) is input to one input conductor 416 (e.g., as a constant voltage for each bit value of zero and one) such that P cycles of computational memory 400 are required to process each digital IA value. Digital weight 902 (e.g., weight W₀) has eight-bits that are divided into a LS nibble 904 and a MS nibble 906, where MS nibble 906, represented as an analog signal, is preloaded into cell 402(0,1) of column 422(1) and LS nibble 904, represented as an analog signal, is preloaded into cell 402(0,2) (e.g., a first cell) of column 422(2). Unlike FIG. 8 where IA is input as an eight-bit value, in the example of FIG. 9, bit zero (e.g., the LSB) of each IA is processed in a first cycle (e.g., j=0) to determine LS partial sum 914(0) and MS partial sum 916(0). In a second cycle (e.g., j=1), bit one of each IA is processed to determine LS partial sum 914(1) and MS partial sum 916(1), and so on until all eight bits are processed to generate LS and MS pairs of partial sums. Accordingly, each bit of the multi-bit IA is processed in a different cycle of computational memory 400.

Each pair of LS partial sum 914 and MS partial sum 916 is shifted left by a number of bits corresponding to a position of the IA bit being input. For example, there is no shift of LS partial sum 914 and MS partial sum 916 when the LS bit (e.g., bit position zero) of IA is input; LS partial sum 914 and MS partial sum 916 are shifted left by one bit when a next bit (e.g., bit position 1) of IA is input, and so on until LS partial sum 914 and MS partial sum 916 are both shifted left by seven bits when the MS bit (e.g., bit 7) of IA is input. In certain embodiments, the shift is implemented based on a processing cycle number (e.g., j from 0 to P−1 where P is the number of bits in each digital IA value) where the cycle number starts at zero for each LS bit of the IA being input. Further, each MS partial sum 916 is shifted left by L bits relative to its corresponding LS partial sum 914 since MS nibble 906 was effectively divided by 2^{L} by the split. For example, where Lis four, MS partial sum 916(0) is shifted left by four bits relative to LS partial sum 914(0). LS partial sums 914(0)-(7) and MS partial sums 916(0)-(7) are then summed to form resulting value 920. This shifting and summing typically occurs in the digital domain.

In the example of FIG. 9, since IA values are bit-sliced and input one bit at a time and each LS nibble 904 and MS nibble 906 is four-bits (e.g., L=4 and H=4), where the number of rows 424(N) in each column is 256, each LS partial sum 914 and MS partial sum 916 requires thirteen-bits. Resulting value 920 requires twenty-four-bits (e.g., similar to resulting value 820 of FIG. 8) to accommodate the summation of the shifted LS partial sums 914 and MS partial sums 916 for each cycle. This functionality is summarized in equations (8), (9), and (10).

$${y}_{0} = \vec{IA} \cdot {\vec{W}}^{T} = {\sum }_{i = 0}^{{2}^{8} - 1} {IA}_{8 b \_ i} \cdot {W}_{8 b \_ i} \qquad ( 8 )$$

$$= [ {2}^{0} … {2}^{7} ] \cdot [ \begin{matrix}{IA}_{8 b \_ 0} [ 0 ] & … & {IA}_{8 b \_ 255} [ 0 ] \\ ⋮ & ⋱ & ⋮ \\ {IA}_{8 b \_ 0} [ 7 ] & … & {IA}_{8 b \_ 255} [ 7 ]\end{matrix} ] \cdot ( [ \begin{matrix}{W}_{a \_ 8 b [ 3 : 0 ] \_ 0} \\ ⋮ \\ {W}_{a \_ 8 b [ 3 : 0 ] \_ 255}\end{matrix} ] + {2}^{4} . [ \begin{matrix}{W}_{b \_ 8 b [ 7 : 5 ] \_ 0} \\ ⋮ \\ {W}_{b \_ 8 b [ 7 : 5 ] \_ 255}\end{matrix} ] ) \qquad ( 9 )$$

$$= {\sum }_{j = 0}^{8 - 1} {2}^{j} \cdot ( {\sum }_{i = 0}^{{2}^{8} - 1} {IA}_{8 b \_ i} [ j ] \cdot {W}_{a \_ 8 b [ 3 : 0 ] \_ i} + {2}^{4} \cdot {\sum }_{i = 0}^{{2}^{8} - 1} {IA}_{8 b \_ i} [ j ] \cdot {W}_{b \_ 8 b [ 7 : 4 ] \_ i} ) \qquad ( 10 )$$

Effectively, this solution performs calculations on fewer bits within each cell 402, thereby this solution improves resolution, reduces the number of bits required for the ADC, and also decreases SQNR, since noise from operation of columns 422(1) and 422(2), which manifests in the least significant few bits of LS partial sums 914 and MS partial sums 916, is not used, and therefore the noise is not shifted and added into resulting value 920. Accordingly, less noise is introduced at higher bit positions, and less noise propagates through subsequent computations of DNN 300. As described above, digital weight may have more or fewer bits and may be divide into multiple portions that are applied to different columns of the cross-bar array, without departing from the scope hereof.

### Improved Noise Reduction

The embodiments disclosed herein improve the state of the art for hybrid analog in-memory computation. Conventionally, the state of the art uses single-bit multiplication and analog summation (charge mode or current mode) over neighboring activation levels. Bit shift and summation for an eight bit word length is typically performed in the digital domain for each input bit of the IA. In this model, one column of cells calculates a value for a next layer (e.g., MACs 304) of a DNN (e.g., DNN 300).

The embodiments disclosed herein implement a multi-bit (e.g., 4b+4b, 5b+5b, 3b+5b) multiplication+multi-bit shift in analog-digital mixed mode (e.g., current mode in case of memristor use, or alternatively charge mode for other memory types). A key aspect of the noise reduction for mixed in-memory computing embodiments described herein is the realization that by dividing the weight over multiple cells, multiplying and accumulating each column, and recombining the totals allows the noise (e.g., LSB(s) of result for each multiplication and summation) to be ignored (e.g., truncated) and thereby prevent noise propagation through subsequent layers of DNN 300.

### Improved Hardware

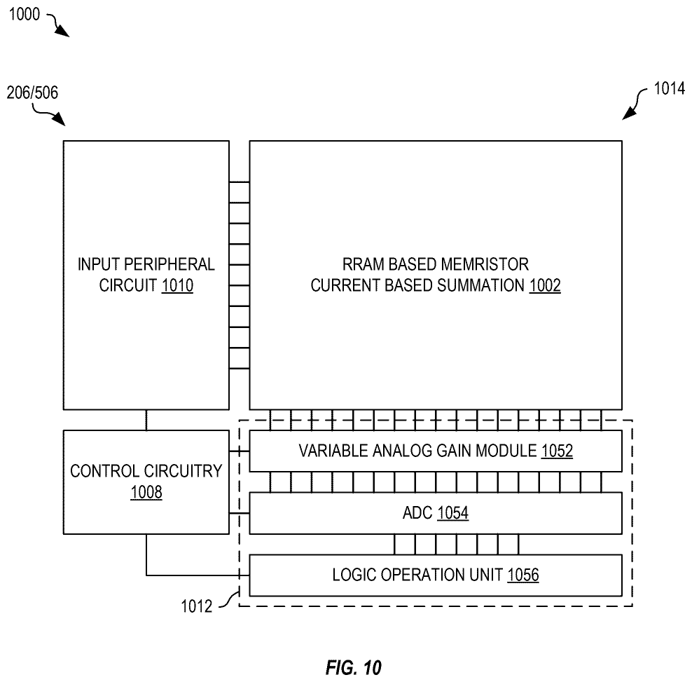

FIG. 10 is a schematic illustrating one example current-domain computational memory 1000 with improved noise reduction and increased SQNR, in embodiments

Computational memory 1000 represents computational memory 206 of FIG. 2 and/or computational block 506 of FIG. 5, for example. However, computational memory 1000 includes additional features that improve SQNR and functionality of computational memory 1000. In this example, computational memory 1000 operates with analog representations of eight-bit IAs and eight-bit digital weights in a current-domain; however, computational memory 1000 may also operate to represent other bit lengths and/or in a charge-domain without departing from the scope hereof.

Computational memory 1000 includes a crossbar 1014 implemented as a resistive random access memory (RRAM) 1002 that uses a memristor array, similar to memristors 502 of FIG. 5, that performs current-based summation. Computational memory 1000 also includes a control circuitry 1008 that is similar to control circuitry 408 and/or 508, and an input peripheral circuit 1010 that is similar to input peripheral circuit 410(1) and/or input peripheral circuit 510(1). Input peripheral circuit 1010 may also include circuitry for preloading RRAM 1002. For example, input peripheral circuit 1010 is controlled by control circuitry 1008 to preload RRAM 1002 with analog representations of digital weights of DNN 300 as described herein. Further, computational memory 1000 allows slicing of digital weights across two or more columns of RRAM 1002.

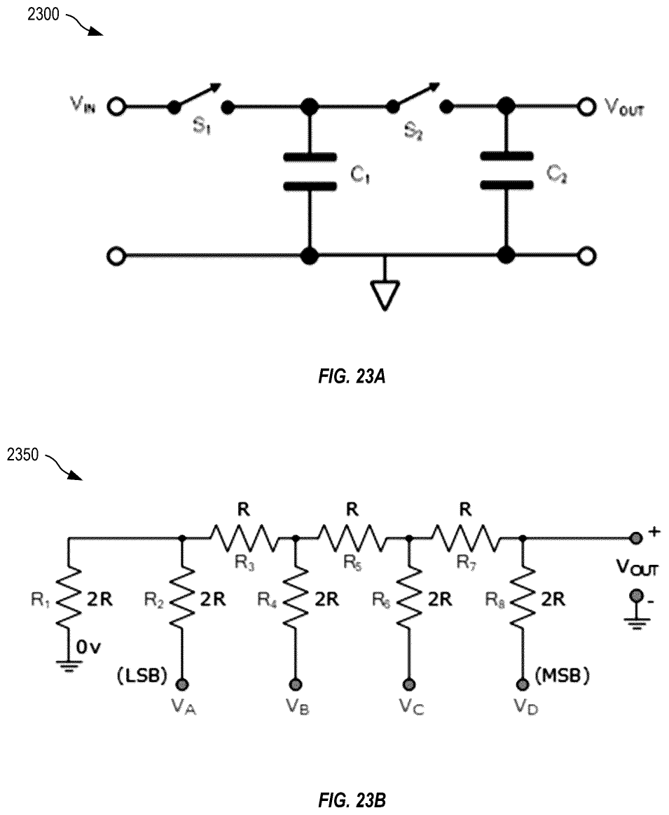

Computational memory 1000 includes an output peripheral circuit 1012 that is improved over output peripheral circuit 412 and output peripheral circuit 512. For example, output peripheral circuit 1012 may include a variable analog gain module 1052 that electrically couples to RRAM 1002, ADC 1054 (e.g., a SAR ADC) with a current digital-to-analog converter (IDAC) or a capacitive digital-to-analog converter (CDAC) that are controllable by control circuitry 1008 to change a gain of signals from RRAM 1002 and/or variable analog gain module 1052. For example, variable analog gain module 1052 may include one or more of an R-2R ladder module 2350 of FIG. 23B and a switched capacitor module 2300 of FIG. 23A to implement gains. Computational memory 1000 also includes a logic operation unit 1056 that may add partial sums generated by ADC 1054 to determine values for subsequent layers of DNN 300 for example.

Computational memory 1000 may be implemented as one of two main embodiments, Embodiment A and Embodiment B, described in detail below. These embodiments illustrate two different method of computational memory 1000 to process IA. In embodiment A, computational memory 1000 processes IA as a multibit value whereas in embodiment B, computational memory 1000 processes IA one bit at a time, which may be referred to as bit-slicing. Where IA is bit sliced, multiple cycles of multiply and summation are required to determine each resulting value (e.g., a value for use is a subsequent layer of the DNN).

### Embodiment A-Multi-Bit Input

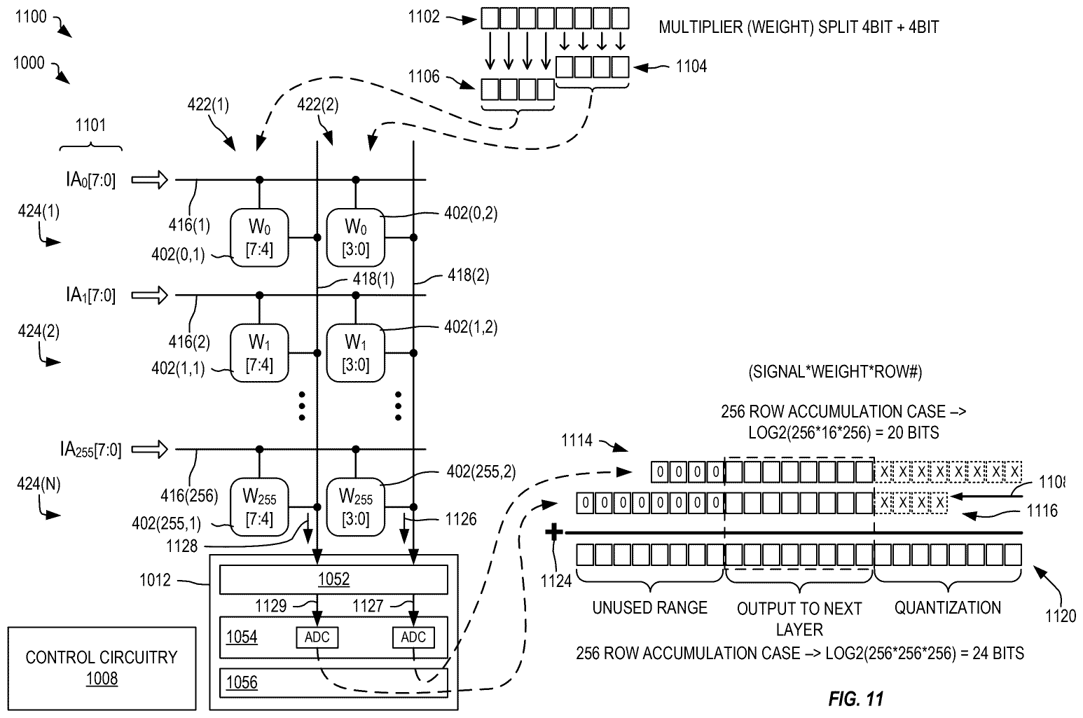

FIG. 11 is a schematic diagram illustrating example operation of computational memory 1000 of FIG. 10 with noise reduction 1100 for multi-bit AI values 1101, in embodiments. FIGS. 10 and 11 are best viewed together with the following description. In this example, each digital weight (e.g., a digital weight 1102 representing weight W₀ of DNN 300) is eight bits (e.g., T=8), that is divided into an LS portion 1104 that has four bits (e.g., where Lis four) set to the four LS bits of digital weight 1102 and an MS portion 1106 that has four bits (e.g., where H is four) set to the four most-significant bits of digital weight 1102 (effectively dividing MS portion 1106 by 2^{L}). MS portion 1106 of each digital weight is applied to cells 402 of column 422(1) and LS portion 1104 of each digital weight is applied to cells 402 of column 422(2). In certain embodiments, digital weight 1102 is split into more than two portions, where each portion is represented as an analog signal that is preloaded into a different column 422 of computational memory 1000. This effectively splits the weight multiplication over multiple columns, reducing the bit requirement of each column and thereby reducing noise, where the captured partial results from these columns are scaled and summed to form the resulting value. In certain embodiments, digital weight 1102 is not split evenly between LS portion 1104 and MS portion 1106, such as where LS portion 1104 is formed of five bits and MS portion 1106 is formed of three bits. In these embodiments, MS partial sum 1116 is appropriately scaled prior to summing with LS partial sum 1114.

Control circuitry 1008 controls input peripheral circuit 1010 to apply input activators IA₀-IA₂₅₅ (e.g., each an eight-bit value converted into an analog signal by a DAC) to input conductors 416(0)-416 (255), respectively, causing each cell 402 to apply a current, corresponding to the multiplication of the weight and IA, to one output conductor 418 of that column 422. For example, output conductor 418(1) of column 422(1) carries an MS output signal 1128 indicative of MAC processing of activators IA₀-IA₂₅₅ multiplied by MS portion 1106 and summed in column 422(1) and output conductor 418(2) of column 422(2) carries an LS output signal 1126 indicative of MAC processing of activators IA₀-IA₂₅₅ multiplied by LS portion 1104 and summed in column 422(2). Control circuitry 1008 sets a gain (e.g., using one or both of variable analog gain module 1052 and ADCs 1054) for each of column 422(1) and column 422(2). In this example, the number of rows in each column is 256. A maximum value output from each column is 256 (IA input of 8-bits)×16 (Weight of 4-bits)×256 (number of rows being summed in each column)=1,048,576. The number of bits required to store this value is Log₂ (1,048,576)=20-bits. That is, each of LS partial sum 1114 and MS partial sum 1116 requires 20-bits to store the full value range. Two columns 422(1) and 422(2) are summed, with MS partial sum 1116 shifted left by four bits (e.g., indicated by arrow 1108, to correct for MS portion 1106 being effectively divided by 2^{L} when digital weight 1102 was split into LS portion 1104 and MS portion 1106), and therefore the total number of bits required for the summed output is Log₂ (256×256×256)=24-bits. The LS 8-bits of resulting value 1120 are truncated to reduce quantization noise, the MS 8-bits of resulting value 1120 are unused range, and only the middle 8-bits of resulting value 1120 are output to subsequent layers of DNN 300.

In one example of operation, control circuitry 1008 controls variable analog gain module 1052 to implement a gain of 1/2⁴ (effectively truncating four LS bits) to MS output signal 1128 to form MS adjusted signal 1129 which is captured as an MS partial sum 1116 using ADCs 1054 and controls variable analog gain module 1052 to implement a gain of 1/2⁸ (effectively truncating eight LS bits) to LS output signal 1126 to form LS adjusted signal 1127, which is captured as an LS partial sum 1114 using ADCs 1054. The difference in applied gains corrects for the effective division of MS portion 1106 caused by the splitting of digital weight 1102 into LS portion 1104 and MS portion 1106. Control circuitry 1008 then controls logic operation unit 1056 to sum 1124 LS output signal 1126 and MS output signal 1128 (as effectively shifted by the truncation) to form resulting value 1120.

In another example of operation, control circuitry 1008 controls variable analog gain module 1052 to implement a gain of 1/2⁴ (effectively truncating four LS bits) to MS output signal 1128 to form MS adjusted signal 1129 and controls variable analog gain module 1052 to implement a gain of 1/2⁸ (effectively truncating eight LS bits) to LS output signal 1126 to form LS adjusted signal 1127. Control circuitry 1008 then controls variable analog gain module 1052 to sum LS adjusted signal 1127 and MS adjusted signal 1129 to form an analog sum signal, which is captured as resulting value 1120 by ADCs 1054.

In another example, control circuitry 1008 controls ADCs 1054 to (a) reduce the number of bits captured to twelve-bits for the given ADC range of LS output signal 1126 as LS partial sum 1114 and (b) reduce the number of bits captured to sixteen-bits for the given ADC range of MS output signal 1128 as MS partial sum 1116, effectively truncating the LS bits from each of LS partial sum 1114 and MS partial sum 1116 and also shifting MS partial sum 1116 relative to LS partial sum 1114 by four bits. Control circuitry 1008 then controls logic operation unit 1056 to sum LS partial sum 1114 and MS partial sum 1116 to form resulting value 1120.

Each of LS partial sum 1114 and MS partial sum 1116 is twenty-bits, since LS portion 1104 and MS portion 1106 are each four bits and resulting value 1120 is twenty-four bits. However, as described above, ADCs 1054 may be controlled to capture fewer bits of LS partial sum 1114 and MS partial sum 1116, as shown in FIG. 11.

Advantageously, truncation of quantization bits (e.g., LS bits) of LS partial sum 1114 and MS partial sum 1116 may be performed in either the analog domain or the digital domain, resulting in improved SNR and thereby reducing propagation of noise to subsequent layers of DNN 300. Accordingly, reliability of DNN 300 is improved.

Equations (11), (12), and (13) represent functionality of computational memory 1000 for this embodiment.

$${y}_{0} = \vec{IA} \cdot {\vec{W}}^{T} \qquad ( 11 )$$

$$= {\sum }_{i = 0}^{{2}^{8} - 1} {IA}_{8 b \_ i} \cdot {W}_{8 b \_ i} \qquad ( 12 )$$

$$= {\sum }_{i = 0}^{{2}^{8} - 1} {IA}_{8 b \_ i} \cdot {W}_{a \_ 8 b [ 3 : 0 ] \_ i} + {2}^{( 4 )} \cdot {\sum }_{i = 0}^{{2}^{8} - 1} {IA}_{8 b \_ i} \cdot {W}_{b \_ 8 b [ 7 : 4 ] \_ i} \qquad ( 13 )$$

This embodiment may be applicable for the below condition of equation (14):

$${y}_{0} = {\sum }_{i = 0}^{{2}^{x} - 1} {IA}_{xb \_ i} \cdot {W}_{a \_ xb [ ( k - 1 ) : 0 ] \_ i} + {2}^{( k - p )} \cdot {\sum }_{i = 0}^{{2}^{x} - 1} {IA}_{xb \_ i} \cdot {W}_{b \_ xb [ x - 1 : ( x - ( k - p ) ] \_ i} \qquad ( 14 )$$

Where x: operation bit, k is the bit depth of memory (x≥k), and p is the number of truncated bits (k≥p).

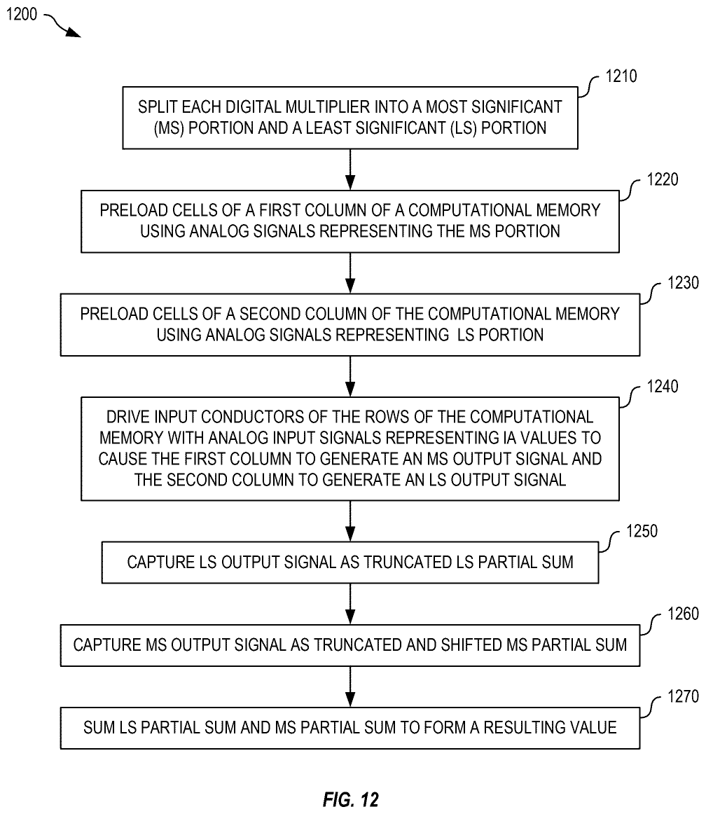

FIG. 12 is a flowchart illustrating one example noise reduction method 1200 for mixed in-memory computing, in embodiments. Method 1200 is implemented by control circuitry 1008 of computational memory 1000 of FIG. 10, for example.

At block 1210, method 1200 split each digital multiplier into an MS portion and an LS portion. In one example of block 1210, control circuitry 1008 splits digital weight 1102 into LS portion 1104 and MS portion 1106, where digital weight 1102 is eight bits, LS portion 1104 is set to the four LS-bits of digital weight 1102 and MS portion 1106 is set to the four MS-bits of digital weight 1102. At block 1220, method 1200 preloads cells of a first column of the computational memory with using analog signals representing the MS portion. In one example of block 1220, control circuitry 1008 controls input peripheral circuit 1010 to preload cell 402(0,1) with an analog signal representation of MS portion 1106, shown as w₀[7:4]. At block 1230, method 1200 preloads cells of a second column of the computational memory using analog signals representing the LS portions. In one example of block 1230, control circuitry 1008 controls input peripheral circuit 1010 to preload cell 402(0,2) with an analog signal representation of LS portion 1104, shown as w₀[3:0].

At block 1240, method 1200 drives input conductors of the computational memory using analog input signals representing IA values to cause the first column to generate an MS output signal and the second column to generate an LS output signal. In one example of block 1240, control circuitry 1008 controls input peripheral circuit 1010 to drive input conductor 416(1) with an analog input signal representative of IA₀[7:0], input conductor 416(2) with an analog input signal representative of IA₁[7:0], and so on, causing column 422(1) to generate MS output signal 1128 on output conductor 418(1) and causing column 422(2) to simultaneously generate LS output signal 1126 on output conductor 418(2).

At block 1250, method 1200 captures LS output signal as truncated LS partial sum. In one example of block 1250, control circuitry 1008 controls variable analog gain module 1052 to set a gain of 1/2⁸ for LS output signal 1126 for capture by ADC 1054. In another example of block 1250, control circuitry 1008 controls ADC 1054 to capture LS output signal 1126 as a twelve-bit value, effectively truncating eight LS-bits.

At block 1260, method 1200 captures MS output signal as truncated and shifted MS partial sum. In one example of block 1260, control circuitry 1008 controls variable analog gain module 1052 to set a gain of 1/2⁴ for MS output signal 1128 for capture by ADC 1054. In another example of block 1260, control circuitry 1008 controls ADC 1054 to capture MS output signal 1128 as a sixteen-bit value, effectively truncating four LS-bits and applying a gain of 2^{L} relative to LS partial sum 1114.

At block 1270, method 1200 sums LS partial sum and MS partial sum to form a resulting value. In one example of block 1270, control circuitry 1008 controls logic operation unit 1056 to add MS partial sum 1116 and LS partial sum 1114 to determine resulting value 1120.

### Embodiment B-Input Bit-Slicing

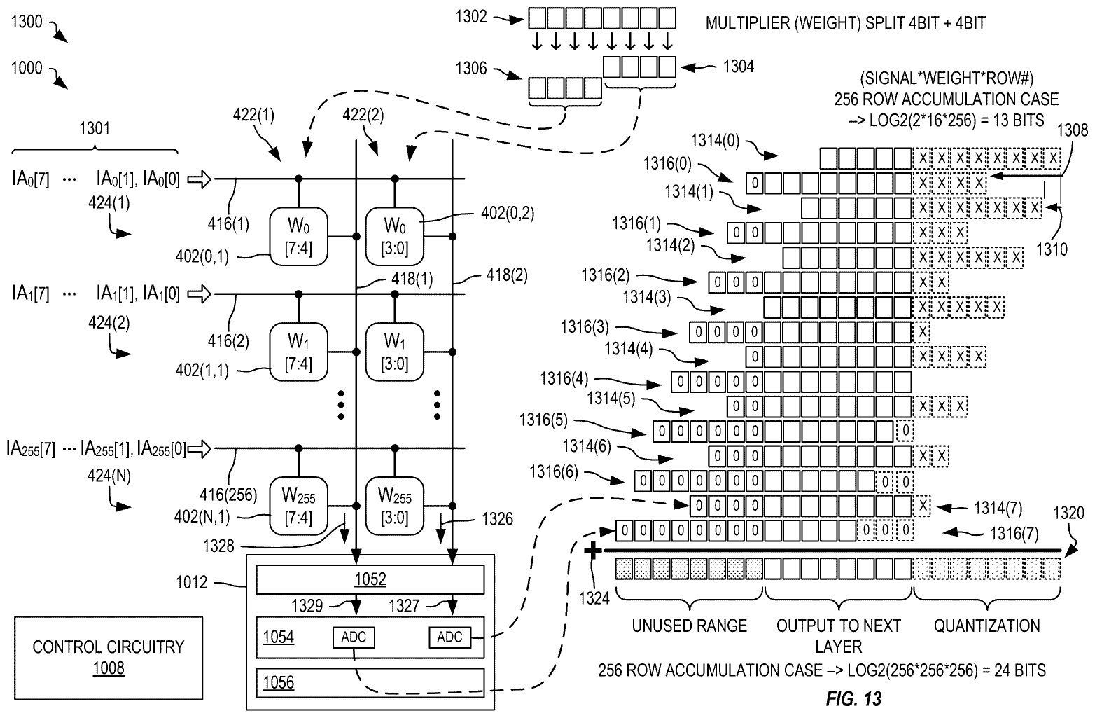

FIG. 13 is a schematic diagram illustrating example operation of computational memory 1000 of FIG. 10 with noise reduction 1300 when IA values are bit-sliced, in embodiments. FIGS. 10 and 13 are best viewed together with the following description. In this example, each digital weight is eight-bits (e.g., shown as a digital weight 1302 representing weight W₀ of DNN 300) that is divided into an LS portion 1304 of the four least-significant bits of digital weight 1302 and an MS portion 1306 of the four most-significant bits of digital weight 1302. MS portion 1306 is preloaded as an analog signal to cells 402 of column 422(1) and LS portion 1304 is preloaded as an analog signal to cells 402 of column 422(2).

As described above for FIG. 9, input bit-slicing causes each IA bit to be input at a different sequential processing cycle (e.g., j is 0-(P−1)) of computational memory 1000, such that each processing cycle generates one MS output signal 1328 and one LS output signal 1326 for each input bit of IA. In this example, the number of rows 424(N) in each column is 256, IA values are eight-bit and are bit-sliced and input to respective rows of computational memory 1000 one bit at a time. Accordingly, each LS partial sum 1314 and MS partial sum 1316 requires thirteen-bits (e.g., log₂ (2*16*256)). Resulting value 1320 requires twenty-four-bits (e.g., similar to resulting value 1120 of FIG. 11) to accommodate the summation of the shifted LS partial sums 1314 and MS partial sums 1316 for each bit of IA input.

### Analog Bit Truncation

In certain embodiments, control circuitry 1008 implements bit truncation through control of variable analog gain module 1052 and/or ADCs 1054 such that the portions of LS output signal 1326 and MS output signal 1328 of interest are positioned in the capture range of ADCs 1054 and the low voltage noise is positioned outside the capture range of the ADCs 1054, and are effectively truncated. For example, where noise occurs in a voltage range captured in the two LS bits of the ADC for each of LS output signal 1326 and MS output signal 1328, by applying a gain of V/4 to each of LS output signal 1326 and MS output signal 1328 the noise is reduced to be below capture range 712 of ADCs 1054. Subsequent shifting and truncation may be applied in the digital domain.

In another example, the shifting and the truncation are performed concurrently in the analog domain. For input of IA₀₋₂₅₅[0] (e.g., cycle j=0 for processing the LS-bit of each IA being input to input conductors 416(0)-(255)), control circuitry 1008 controls variable analog gain module 1052 to implement a gain of 1/2⁸ for LS output signal 1326 to form LS adjusted signal 1327, and a gain of 1/2⁴ for MS output signal 1328 to form MS adjusted signal 1329. Control circuitry 1008 then controls ADC 1054 coupled with output conductor 418(2) of column 422(2) to capture as LS adjusted signal 1327 as LS partial sum 1314(0), and controls ADC 1054 coupled with output conductor 418(1) of column 422(1) to capture MS adjusted signal 1329 as MS partial sum 1316(0). LS partial sum 1314(0) occupies the five-LS bits of the captured value of ADC 1054 corresponding to column 422(2) and MS partial sum 1316(0) occupies the eight-LS bits of the captured value of ADC 1054 corresponding to column 422(1).

Continuing with this example for a next cycle (e.g., cycle j=1 to process a next bit of IA) of computational memory 1000, for input of IA₀₋₂₅₅[1] on input conductors 416(0-255), control circuitry 1008 controls variable analog gain module 1052 to implement a gain of 1/2⁷ for LS output signal 1326, and a gain of 1/2³ for MS output signal 1328. Control circuitry 1008 then controls ADC 1054 coupled with output conductor 418(2) of column 422(2) to capture LS partial sum 1314(1), which occupies the six-LS bits of the captured value, and controls ADC 1054 coupled with output conductor 418(1) of column 422(1) to capture MS partial sum 1316(1), which occupies the eight-LS bits of the captured value. This process is continued for each input cycle. For example, control circuitry 1008 controls variable analog gain module 1052 to implement gains of 1/2⁶ and 1/2² for LS output signal 1326 and MS output signal 1328, respectively, in cycle j=2, gains of 1/25 and 21 for LS output signal 1326 and MS output signal 1328, respectively, in cycle j=3, and gains of 1/2⁴ and 1/2⁰ (e.g., a gain of one) for LS output signal 1326 and MS output signal 1328, respectively, in cycle j=4. In cycle j=5, control circuitry 1008 controls variable analog gain module 1052 to implement a gain of 1/2³ for LS output signal 1326 and a gain of one for MS output signal 1328, controls ADCs 1054 to capture LS partial sum 1314(5) and MS partial sum 1316(5), and then applies a digital 1-bit left shift (inserting a zero bit) to MS partial sum 1316(5). In cycle j=6, circuitry 1008 controls variable analog gain module 1052 to implement a gain of 1/2² for LS output signal 1326 and a gain of one for MS output signal 1328, controls ADCs 1054 to capture LS partial sum 1314(6) and MS partial sum 1316(6), and then applies a digital 2-bit left shift (inserting a zero bits) to MS partial sum 1316(6). In cycle j=7, circuitry 1008 controls variable analog gain module 1052 to implement a gain of 1/2¹ for LS output signal 1326, controls ADCs 1054 to capture LS partial sum 1314(7) and MS partial sum 1316(7), and then applies a digital 3-bit left shift (inserting a zero bits) to MS partial sum 1316(7).

A difference between analog gains applied to LS output signal 1326 and MS output signal 1328 effectively implements a gain of 2⁴ to MS partial sum 1316 (e.g., an effective shift left of four bits as indicated by arrow 1308) relative to LS partial sum 1314 (effectively restoring the 2⁴ division resulting from the split of digital weight 1302 into LS portion 1304 and MS portion 1306).

As shown in FIG. 13 (similar to the example of FIG. 9), the modified gains (or bit shifts applied to MS partial sum 1316 for cycles j=5 through j=7) further results in an effective one-bit left shift of each pair of LS partial sum 1314 and MS partial sum 1316 relative to a previous cycle, thereby implementing a gain corresponding to a position of the IA bit being input for that cycle. For example, no shift is performed on LS partial sum 1314(0) and MS partial sum 1316(0) for cycle j=0; LS partial sum 1314(1) and MS partial sum 1316(1) are each shifted left by one bit (e.g., see arrow 1310) for cycle j=1; LS partial sum 1314(2) and MS partial sum 1316(2) are each further shifted left by one-bit for cycle j=2; and so on.

Control circuitry 1008 then controls logic operation unit 1056 to sum 1324 LS partial sums 1314 and MS partial sums 1316 to generate resulting value 1320. In this example, eight LS bits are effectively truncated from resulting value 1320, the eight MS bits are unused, and the middle eight bits form an output to a next layer of DNN 300.

Equation (15) illustrates the calculation performed by computational memory 1000 to determine y₀ for this embodiment.

$${y}_{0} = {\sum }_{j = 0}^{8 - 1} {2}^{j} \cdot ( {\sum }_{i = 0}^{{2}^{8} - 1} {IA}_{8 b \_ i} [ j ] \cdot {W}_{a \_ 8 b [ 4 : 0 ] \_ i} + {2}^{4} \cdot {\sum }_{i = 0}^{{2}^{8} - 1} {IA}_{8 b \_ i} [ j ] \cdot {W}_{b \_ 8 b [ 7 : 5 ] \_ i} ) \qquad ( 15 )$$

The following equations illustrate the calculation of each partial sum, where i represents the cycle (e.g., , bit position 0-7) if the bit slicing of AI and j represents the row 424 being input. Each LS partial sum 1314 is calculated as using equation (16), and each MS partial sum 1316 is calculated using equation (17).

$$LS Patrial Sum = {\sum }_{i = 0}^{{2}^{8} - 1} {IA}_{8 b \_ i} [ j ] \cdot {W}_{a \_ 8 b [ 3 : 0 ] \_ i} \qquad ( 16 )$$

$$MS Patrial Sum = {\sum }_{i = 0}^{{2}^{8} - 1} {IA}_{8 b \_ i} [ j ] \cdot {W}_{a \_ 8 b [ 7 : 5 ] \_ i} \qquad ( 17 )$$

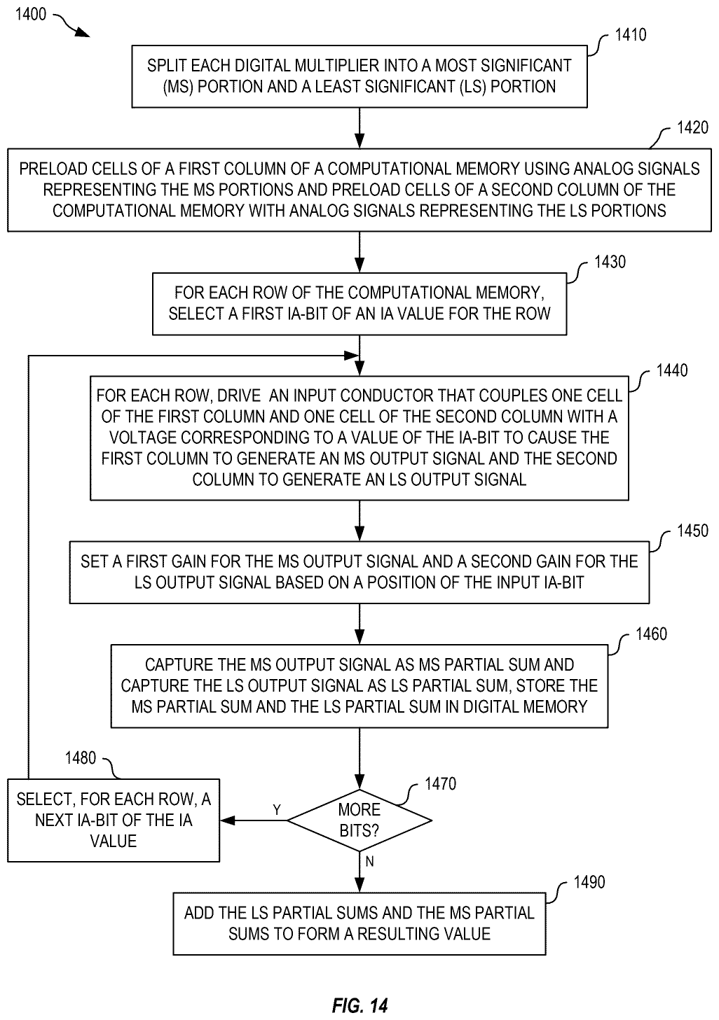

FIG. 14 is a flowchart illustrating one example noise reduction method 1400 for mixed in-memory computing with bit-slicing to input IA, in embodiments. Method 1400 is implemented by control circuitry 1008 of computational memory 1000 of FIG. 10, for example, and follows the embodiments of FIG. 13.

At block 1410, method 1400 splits each digital multiplier into an MS portion and an LS portion. In one example of block 1410, control circuitry 1008 splits digital weight 1302 (W₀ of a first layer of DNN 300) into LS portion 1304 and MS portion 1306, where digital weight 1302 is eight bits, LS portion 1304 is set to the four LS-bits of digital weight 1302 and MS portion 1306 is set to the four MS-bits of digital weight 1302, repeating for other weights W₁-W₂₅₅. At block 1420, method 1400 preloads cells of a first column of a computational memory with analog signals representing the MS portions and preloads cells of a second column of the computational memory with analog signals representing the LS portions. In one example of block 1420, control circuitry 1008 controls input peripheral circuit 1010 to preload cell 402(0,1) with an analog signal representing MS portion 1306 (W₀[7:4]), to preload cell 402(0,2) with an analog signal representing LS portion 1304 (W₀[3:1]), and repeating for other weights W₁-W₂₅₅ of the other rows.

At block 1430, for each row of the computational memory, method 1400 selects an IA-bit of an AI value for the row. In one example of block 1430, control circuitry 1008 controls input peripheral circuit 1010 to select IA₀[0] as an AI-bit for row 424(1), to select IA₁[0] as an AI-bit for row 424(2), and so on.

At block 1440, for each row, method 1400 drives an input conductor coupling one cell of the first column and one cell of the second column with a voltage corresponding to a value of the IA-bit causing the first column to generate an MS output signal and the second column to generate an LS output signal. In one example of block 1440, control circuitry 1008 controls input peripheral circuit 1010 to drive input conductor 416(1) with a first reference voltage (e.g., zero volts) when a value of IA₀[0] is zero and to drive input conductor 416(1) with a second reference voltage (e.g., one volt) when the value of IA₀[0] is one, repeating for other rows 424. These reference voltages may be any voltage between zero and the supply voltage (e.g., greater than zero and less than three volts).

At block 1450, method 1400 sets a first gain for the MS output signal and a second gain for the LS output signal based on a bit position of the IA-bit. In one example of block 1450, when the current processing cycle j represents a position of the IA-bit being input (e.g., j=0 for IA [0], j=1 for IA [1], and so on), control circuitry 1008 controls variable analog gain module 1052 to apply a gain of 2^{4-j} to MS output signal 1328 and apply a gain of 2^{8-j} to LS output signal 1326.

At block 1460, method 1400 capture the MS output signal as MS partial sum and capture the LS partial signal as LS partial sum, and store the MS partial sum and the LS partial sum in digital memory. In one example of block 1460, control circuitry 1008 controls ADCs 1054 to capture MS partial sum 1316 from MS output signal 1328 on output conductor 418(1) and controls ADCs 1054 to capture LS partial sum 1314 from LS output signal 1326 on output conductor 418(2). MS partial sum 1316 and LS partial sum 1314 are stored in memory of logic operation unit 1056.

Block 1470 is a decision. If, in block 1470, method 1400 determines that there are more bits of the IA to input, method 1400 continues with block 1480; otherwise, method 1400 continues with block 1490. In block 1480, for each row, method 1400 selects a next IA-bit of the IA value. In one example of block 1480, control circuitry 1008 controls input peripheral circuit 1010 to select IA₀[1] as a next IA-bit after IA₀[0] for input to row 424(1), to select IA₁[1] as IA-bit for input to row 424(2), and so on. Method 1400 then continues with block 1440. Blocks 1440 through 1480 repeat for each bit of the IA values being input.

At block 1490, method 1400 adds the LS partial sum and the MS partial sum to form a resulting value. In one example of block 1490, control circuitry 1008 controls logic operation unit 1056 to add MS partial sums 1316(0)-(7) and LS partial sums 1314(0)-(7) to form resulting value 1320, where resulting value 1320 forms an output to a next layer of DNN 300. Method 1400 repeats for each pair of columns that generate an output to the next layer of DNN 300.

### 1^{st} Embodiment

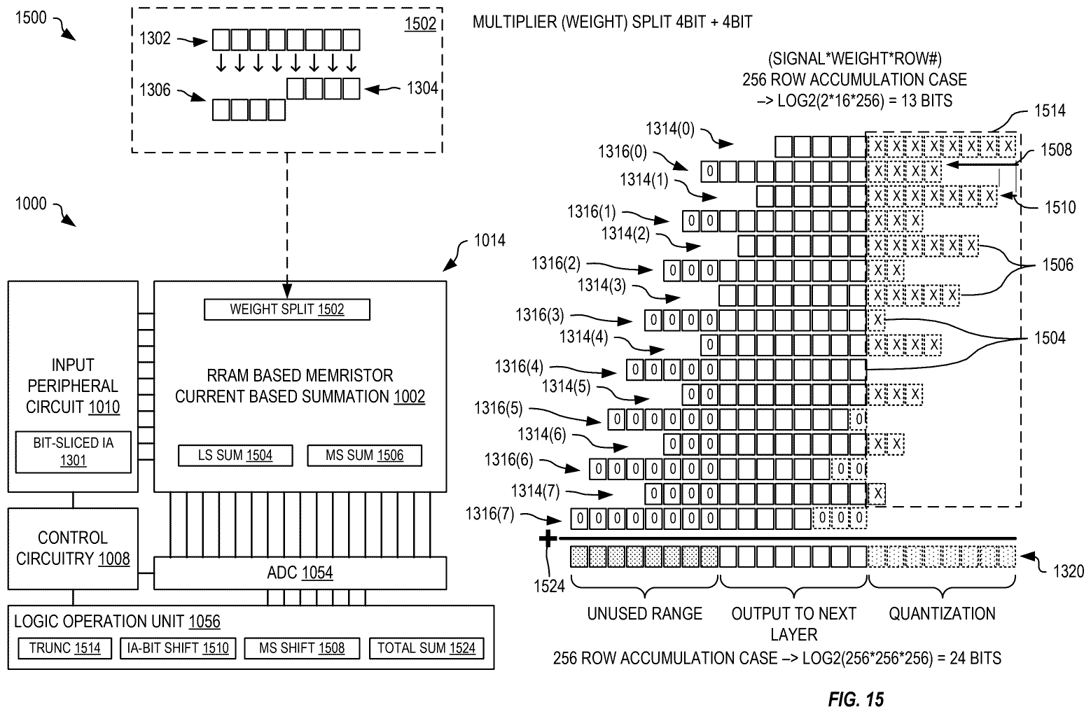

FIG. 15 shows one example implementation 1500 of computational memory 1000 of FIG. 10 with noise reduction 1300 of FIG. 13 when IA values are bit-sliced 1301, where bit truncating 1514, MS shifting 1508, IA-bit shifting 1510, and total summing 1524 are performed in the digital domain, in embodiments.

In operation, implementation 1500 follows the example of noise reduction 1300. Weight splitting 1502 represents the splitting of digital weight 1302 into LS portion 1304 and MS portion 1306, which are preloaded as analog signals into RRAM 1002 as described above. Accordingly, weight splitting 1502 is shown within RRAM 1002. LS summing 1504 and MS summing 1506 represent MAC calculations performed by two columns 422 of RRAM 1002 and are shown within RRAM 1002.

Bit truncating 1514, MS shifting 1508, and IA-bit shifting 1510 are implemented in the digital domain by logic operation unit 1056. Logic operation unit 1056 truncates LS bits of each of LS partial sums 1314(0)-(7) and MS partial sum 1316(0)-(3), where MS partial sums 1316 are shifted left by four-bits relative to LS partial sum 1314, and both LS partial sum 1314 and MS partial sum 1316 are shifted left according to the current cycle j, as illustrated in FIG. 15.

Total summing 1524 represents the summing of LS partial sums 1314 and MS partial sums 1316 to form resulting value 1320 and is performed by logic operation unit 1056. In certain embodiments, operations of bit truncating 1514, MS shifting 1508, IA-bit shifting 1510, and total summing 1524 are combined. For example, bit truncating 1514, MS shifting 1508 and IA-bit shifting 1510 may be implemented by right-shift operations in values captured by ADCs 1054 and total summing 1524 may be performed incrementally at the end of each input cycle.

### 2^{nd} Embodiment

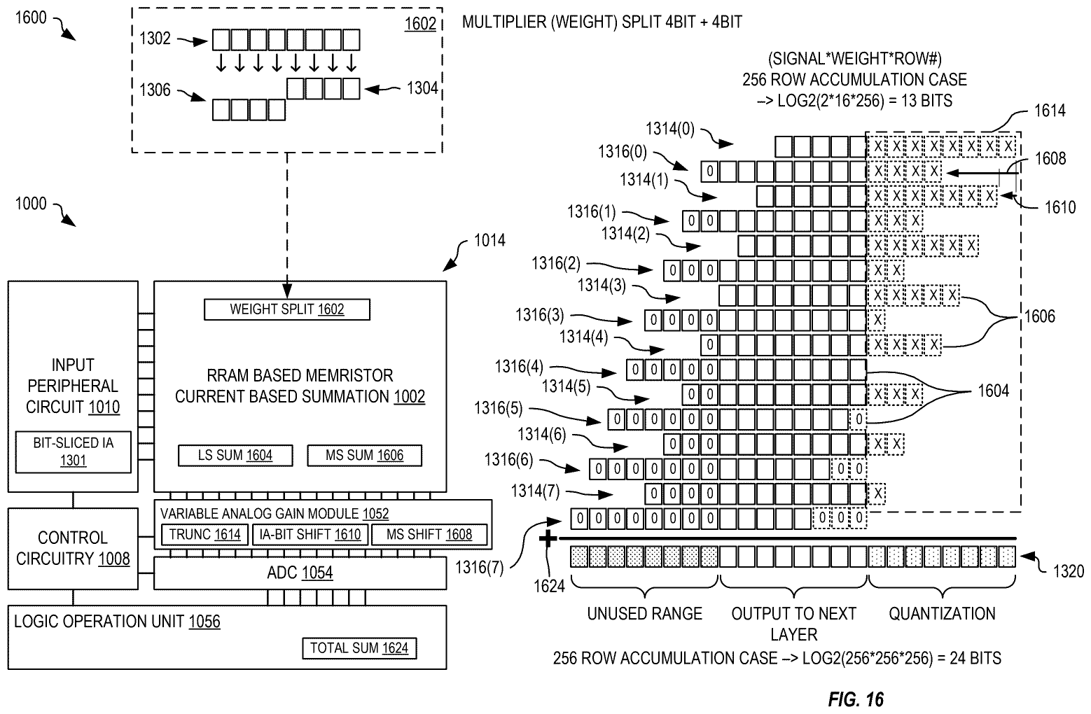

FIG. 16 shows one example implementation 1600 of computational memory 1000 of FIG. 10 with noise reduction 1300 of FIG. 13 when IA values are bit-sliced 1301, where bit truncating 1614, MS shifting 1608, and IA-bit shifting 1610 are performed in the analog domain, and where total summing 1624 is performed in the digital domain, in embodiments.

In operation, implementation 1600 follows the example of noise reduction 1300. Weight splitting 1602 represents the splitting of digital weight 1302 into LS portion 1304 and MS portion 1306, which are preloaded as analog signals into RRAM 1002 as described above. Accordingly, weight splitting 1602 is shown within RRAM 1002. LS summing 1604 and MS summing 1606 represent MAC calculations performed by two columns 422 of RRAM 1002 and therefore LS summing 1604 and MS summing 1606 are shown within RRAM 1002.

MS shifting 1608 represents the four bit left shift of MS partial sums 1316 relative to LS partial sum 1314 and is implemented by variable analog gain module 1052. IA-bit shifting 1610 represents the left bit shift of both LS partial sum 1314 and MS partial sum 1316 according to the current cycle j and is also implemented by variable analog gain module 1052. Bit truncating 1614 is also implemented in the analog domain as described above for noise reduction 1300 of FIG. 13 and sets a gain for each of LS output signal 1326 and MS output signal 1328 causing noise and/or unwanted signal to be outside the bits captured by ADCs 1054. For example, for each input cycle j, control circuitry 1008 controls variable analog gain module 1052 to (a) implement a gain of V/2^{8-j} on LS output signal 1326 prior to capture of LS partial sum 1314(0) by ADC 1054, and (b) implement a gain of V/2^{4-j} on MS output signal 1328 prior to capture of MS partial sum 1316(0). Accordingly, variable analog gain module 1052 (and/or ADCs 1054) adjusts each of LS output signal 1326 and MS output signal 1328 to cause noise and/or unwanted signal to be outside capture range 712/772 of ADCs 1054. Particularly, the applied gain also effectively shifts the captured value to implement IA-bit shifting 1610 and MS shifting 1608.

Total summing 1624 is performed by logic operation unit 1056 which sums LS partial sum 1314 and MS partial sum 1316 for each input cycle j to form resulting value 1320.

### 3^{rd} Embodiment

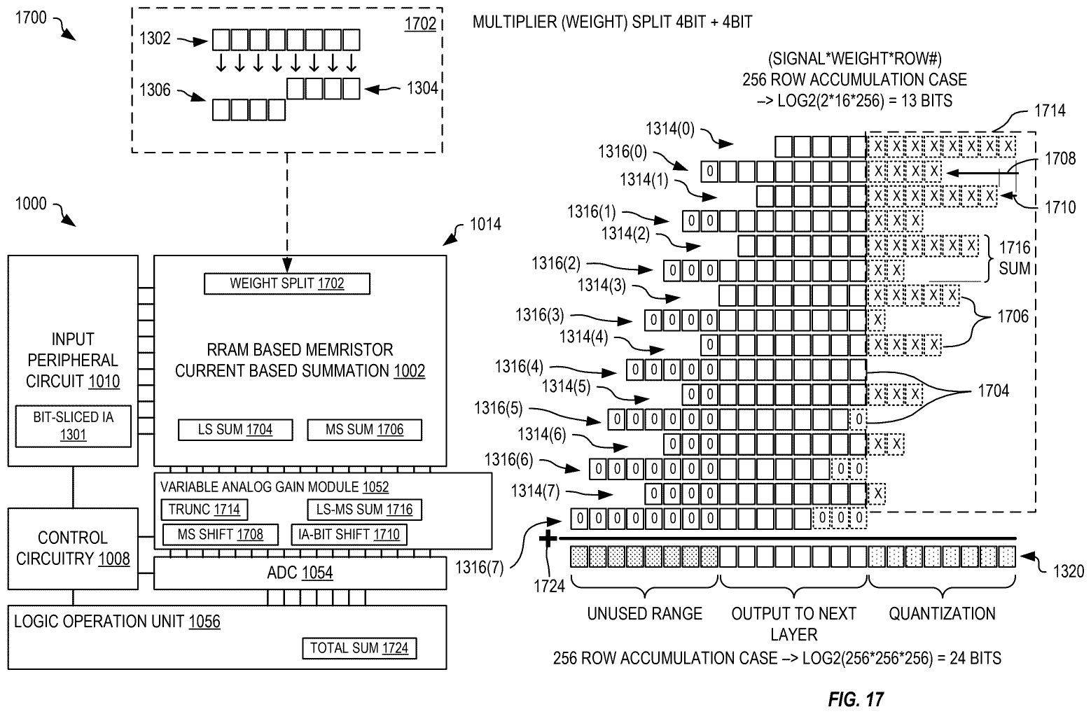

FIG. 17 shows one example implementation 1700 of computational memory 1000 of FIG. 10 with noise reduction 1300 of FIG. 13 when IA values are bit-sliced 1301, where bit truncating 1714, MS shifting 1708, IA-bit shifting 1710, and LS-MS summing 1716 are performed in the analog domain, and where total summing 1724 is performed in the digital domain, in embodiments.

In operation, implementation 1700 follows the example of noise reduction 1300. Weight splitting 1702 represents the splitting of digital weight 1302 into LS portion 1304 and MS portion 1306, which are preloaded as analog signals into RRAM 1002 as described above. Accordingly, weight splitting 1702 is shown within RRAM 1002. LS summing 1704 and MS summing 1706 represent MAC calculations performed by two columns 422 of RRAM 1002 and therefore LS summing 1704 and MS summing 1706 are shown within RRAM 1002.

MS shifting 1708 represents the four bit left shift of MS partial sums 1316 relative to LS partial sum 1314 and is implemented by variable analog gain module 1052. IA-bit shifting 1710 represents the left bit shift of both LS partial sum 1314 and MS partial sum 1316 according to the current cycle j and is also implemented by variable analog gain module 1052. Bit truncating 1714 is also implemented in the analog domain as described above for noise reduction 1300 of FIG. 13 and sets a gain for each of LS output signal 1326 and MS output signal 1328 causing noise to be outside the bits captured by ADCs 1054. For example, for each input cycle j, control circuitry 1008 controls variable analog gain module 1052 to (a) implement a gain of V/2^{8-j} on LS output signal 1326 prior to capture of LS partial sum 1314(0) by ADC 1054, and (b) implement a gain of V/2^{4-j} on MS output signal 1328 prior to capture of MS partial sum 1316(0). Accordingly, variable analog gain module 1052 (and/or ADCs 1054) adjusts each of LS output signal 1326 and MS output signal 1328 to cause noise and/or unwanted signal to be outside capture range 712/772 of ADCs 1054. Particularly, the applied gain also effectively shifts the captured value to implement IA-bit shifting 1710 and MS shifting 1708.

Variable analog gain module 1052 is further configured to sum LS output signal 1326 and MS output signal 1328 (after the applied gains) and control circuitry 1008 control ADCs 1054 to capture a LS-MS sum value for each input cycle j. That is, a single digital value representing the sum of LS partial sum 1314 and MS partial sum 1316 is captured and input to logic operation unit 1056 for each input cycle.

Total summing 1724 represents the summing of these single digital values to form resulting value 1320 and is performed by logic operation unit 1056.

### 4^{th} Embodiment

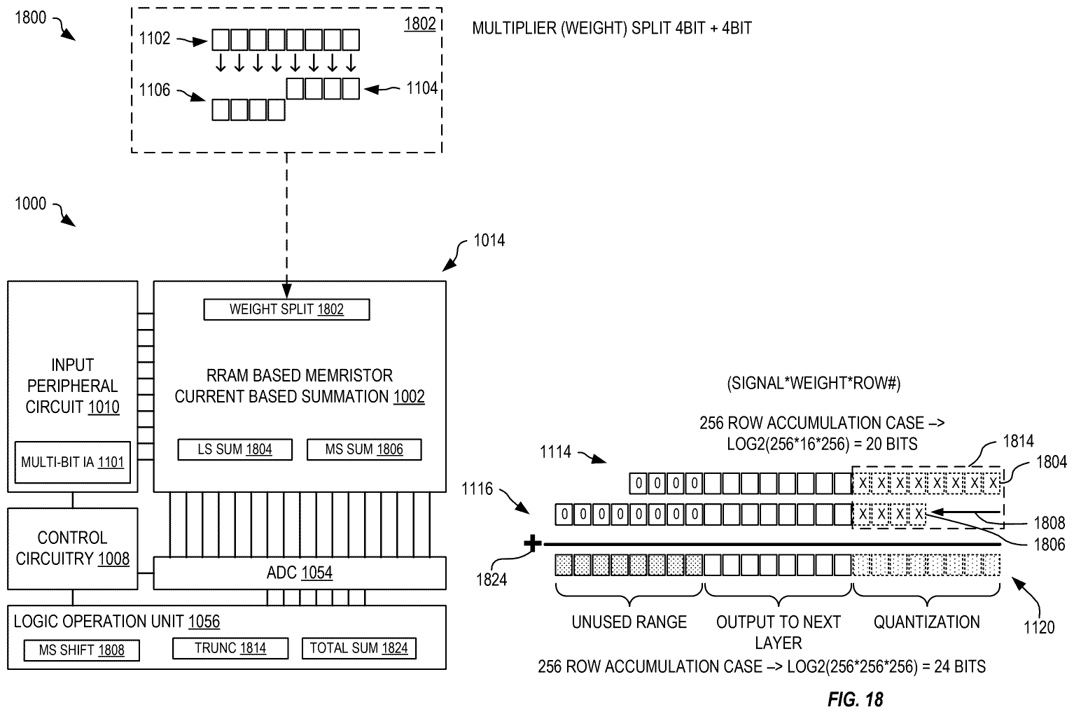

FIG. 18 shows one example implementation 1800 of computational memory 1000 of FIG. 10 with noise reduction 1100 of FIG. 11 when IA values are multi-bit, where bit truncating 1814, MS shifting 1808 and total summing 1824 are performed in the digital domain, in embodiments.

In operation, implementation 1800 follows the example of noise reduction 1100. Weight splitting 1802 represents the splitting of digital weight 1102 into LS portion 1104 and MS portion 1106, which are preloaded as analog signals into RRAM 1002 as described above. Accordingly, weight splitting 1802 is shown within RRAM 1002. LS summing 1804 and MS summing 1806 represent MAC calculations performed by two columns 422 of RRAM 1002 and are shown within RRAM 1002.

Bit truncating 1814, MS shifting 1808, and total summing 1824 are implemented in the digital domain by logic operation unit 1056. Logic operation unit 1056 shifts LS partial sum 1114 right by eight-bits, effectively truncating the eight LS-bits. Logic operation unit 1056 shifts MS partial sum 1116 right by four-bits, effectively truncating the four LS-bits. The difference between the shifts (e.g., four-bits) effectively implements MS shifting 1808. Logic operation unit 1056 then sums LS partial sum 1114 and MS partial sum 1116 to form resulting value 1120.

### 5^{th} Embodiment

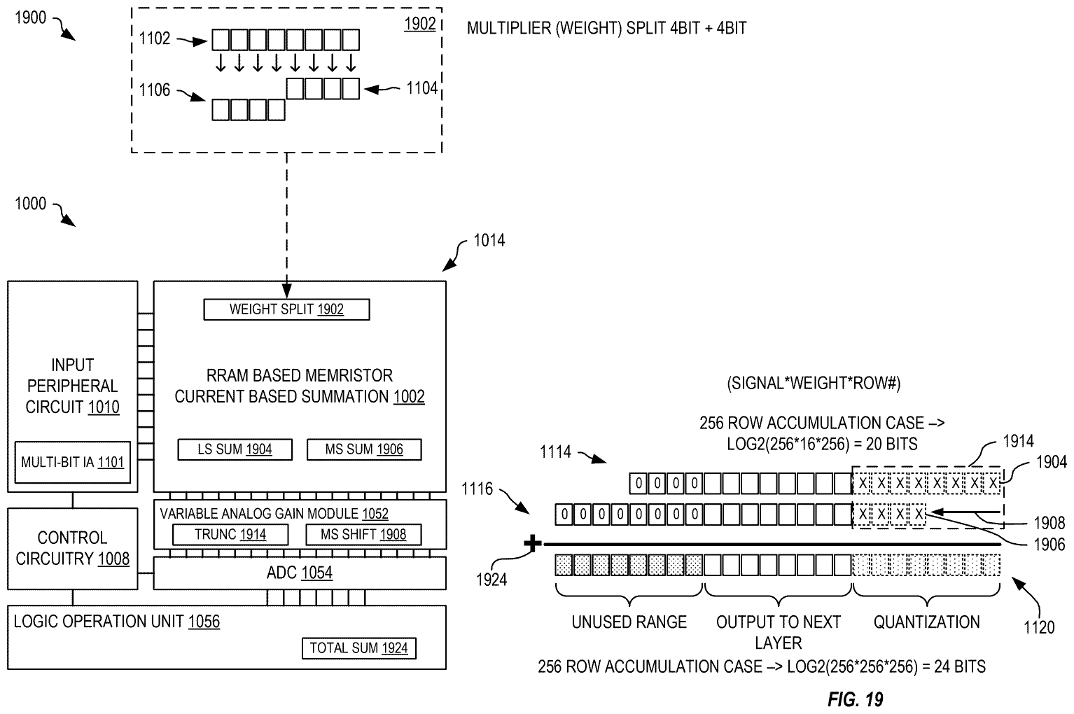

FIG. 19 shows one example implementation 1900 of computational memory 1000 of FIG. 10 with noise reduction 1100 of FIG. 11 when IA values are multi-bit, where bit truncating 1914 and MS shifting 1908 are performed in the analog domain, and where total summing 1924 is performed in the digital domain, in embodiments.

In operation, implementation 1900 follows the example of noise reduction 1100. Weight splitting 1902 represents the splitting of digital weight 1102 into LS portion 1104 and MS portion 1106, which are preloaded as analog signals into RRAM 1002 as described above. Accordingly, weight splitting 1902 is shown within RRAM 1002. LS summing 1904 and MS summing 1906 represent MAC calculations performed by two columns 422 of RRAM 1002 and are shown within RRAM 1002.

MS shifting 1908 represents the four bit left shift of MS partial sums 1116 relative to LS partial sum 1114 and is implemented by variable analog gain module 1052. Bit truncating 1914 is also implemented in the analog domain as described above for noise reduction 1100 of FIG. 11 and sets a gain for each of LS output signal 1126 and MS output signal 1128 causing noise to be outside the bits captured by ADCs 1054. For example, control circuitry 1008 controls variable analog gain module 1052 to (a) implement a gain of V/2⁸ on LS output signal 1126 prior to capture of LS partial sum 1114 by ADC 1054, and (b) implement a gain of V/2⁴ on MS output signal 1128 prior to capture of MS partial sum 1116. Accordingly, variable analog gain module 1052 (and/or ADCs 1054) adjusts each of LS output signal 1126 and MS output signal 1128 to cause noise and/or unwanted signal to be outside capture range 712/772 of ADCs 1054, thereby effectively truncating the eight LS-bits of LS partial sum 1114 and truncating the four LS-bits of MS partial sum 1116. The difference between the gains applied to LS output signal 1126 and MS output signal 1128 also effectively implements MS shifting 1908.

Logic operation unit 1056 implements total summing 1924 by summing of LS partial sum 1114 and MS partial sum 1116 to form resulting value 1120.

### 6^{th} Embodiment

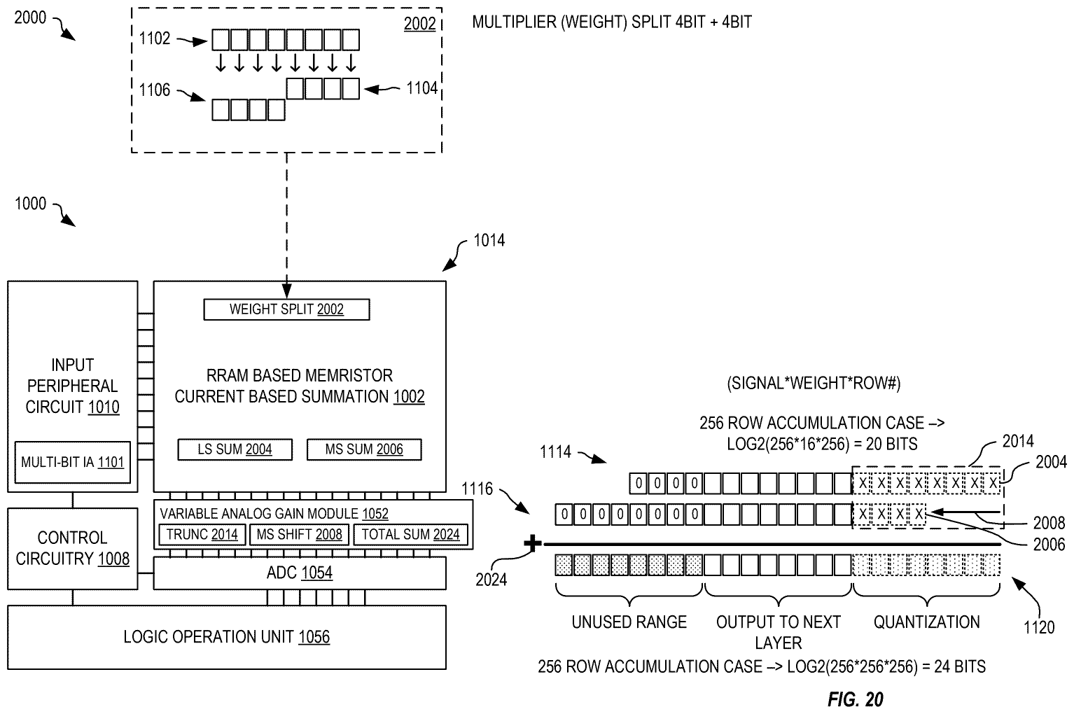

FIG. 20 shows one example implementation 2000 of computational memory 1000 of FIG. 10 with noise reduction 1100 of FIG. 11 when IA values are multi-bit, where bit truncating 2014, MS shifting 2008, and total summing 2024 are performed in the analog domain, in embodiments.

In operation, implementation 2000 follows the example of noise reduction 1100. Weight splitting 2002 represents the splitting of digital weight 1102 into LS portion 1104 and MS portion 1106, which are preloaded as analog signals into RRAM 1002 as described above. Accordingly, weight splitting 2002 is shown within RRAM 1002. LS summing 2004 and MS summing 2006 represent MAC calculations performed by two columns 422 of RRAM 1002 and are shown within RRAM 1002.

MS shifting 2008 represents the four bit left shift of MS partial sums 1116 relative to LS partial sum 1114 and is implemented by variable analog gain module 1052. Bit truncating 2014 is also implemented in the analog domain as described above for noise reduction 1100 of FIG. 11 and sets a gain for each of LS output signal 1126 and MS output signal 1128 causing noise and/or unwanted signal to be outside capture range 712/772 of ADCs 1054. For example, control circuitry 1008 controls variable analog gain module 1052 to (a) implement a gain of V/2⁸ on LS output signal 1126 prior to capture of LS partial sum 1114 by ADC 1054, and (b) implement a gain of V/2⁴ on MS output signal 1128 prior to capture of MS partial sum 1116. Accordingly, variable analog gain module 1052 (and/or ADCs 1054) adjusts each of LS output signal 1126 and MS output signal 1128 to cause noise and/or unwanted signal to be outside capture range 712/772 of ADCs 1054. The difference between the gains applied to LS output signal 1126 and MS output signal 1128 also effectively implements MS shifting 2008.

Variable analog gain module 1052 is further configured to sum LS output signal 1126 and MS output signal 1128 (after the applied gains) and control circuitry 1008 control ADCs 1054 to capture resulting value 1120. That is, a single digital value representing the sum of LS partial sum 1114 and MS partial sum 1116 is captured and input to logic operation unit 1056.

### Bit Truncation Embodiments

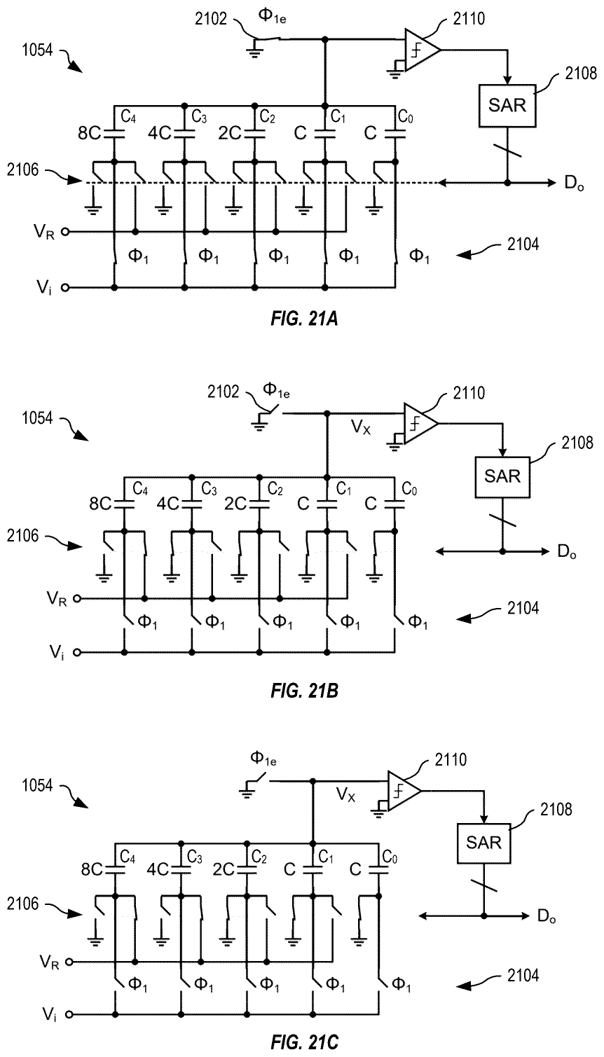

FIGS. 21A, 21B, and 21C are schematic diagrams illustrating capture and conversion of an input voltage Vᵢ without gain adjustment by ADCs 1054 of FIG. 10, in embodiments. FIGS. 21A, 21B, and 21C are best viewed together with the following description.

FIG. 21A illustrates configuration of CDAC capacitors to capture input voltage Vᵢ during an initial acquisition phase of analog to digital conversion, where all switches 2102 and 2104 are closed to connect the capacitors between ground and Vᵢ. FIG. 21B shows a first conversion phase of ADC 1054, where switches 2102 and 2104 are opened, capacitor C₄ is connected to V_{R}, and capacitors C₃, C₂, C₁, and C₀ are connected to ground. A voltage V_{X} presented to comparator 2110 of ADC 1054 based on capacitor charge redistribution and their connectivity between ground or V_{R} by switches 2106 is defined by equations (18) and (19).

$${V}_{i} \cdot 16 C = ( {V}_{R} - {V}_{x} ) {C}_{4} - {V}_{x} ( {C}_{3} + {C}_{2} + {C}_{1} + {C}_{0} ) \qquad ( 18 )$$

$${V}_{x} = \frac{{V}_{R} \cdot 8 C - {V}_{i} \cdot 16 C}{16 C} = \frac{{V}_{R}}{2} - {V}_{i} \qquad ( 19 )$$

FIG. 21C shows subsequent conversion phases of ADC 1054, where switches 2102 and 2104 are opened and switches 2106 are controlled by SAR 2108 as the conversion proceeds. In this example, a values of the SAR is 1100, causing capacitors C₄ and C₃ to connect to V_{R}, and capacitors C₂, C₁, and C₀ to connect to ground. The voltage presented to comparator 2110 of ADC 1054 based on capacitor charge redistribution and their connectivity between ground or V_{R} by switches 2106 is defined by equations (20) and (21).

$${V}_{i} \cdot 16 C = ( {V}_{R} - {V}_{x} ) \cdot 16 C - {V}_{x} \cdot 4 C \qquad ( 20 )$$

$${V}_{x} = \frac{{V}_{R} \cdot 12 C - {V}_{i} \cdot 16 C}{16 C} = \frac{3}{4} {V}_{R} - {V}_{i} \qquad ( 21 )$$

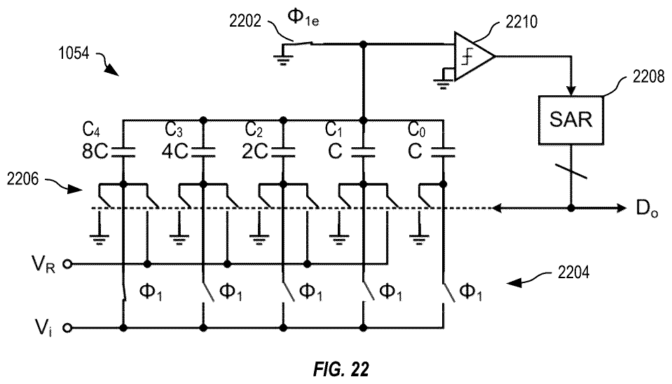

FIG. 22 is a schematic diagram illustrating an alternative initial acquisition phase of ADC 1054 to implement a gain of 1/2, in embodiments. In this example, switch 2202 is closed, switches 2206 are open, and switches 2204 are controlled to connect only capacitors C₄ and C₀ to Vᵢ. In this example, voltage V_{X} presented to comparator 2210 of ADC 1054 based on capacitor charge redistribution of capacitor C₄ and their connectivity between ground or V_{R} by switches 2206 (e.g., controlled by SAR 2208 during conversion phases) is defined by equations (22) and (23).

$${V}_{i} \cdot 8 C = ( {V}_{R} - {V}_{x} ) {C}_{4} - {V}_{x} ( {C}_{3} + {C}_{2} + {C}_{1} + {C}_{0} ) \qquad ( 22 )$$

$${V}_{x} = \frac{{V}_{R} \cdot 8 C - {V}_{i} \cdot 8 C}{16 C} = \frac{{V}_{R}}{2} - \frac{{V}_{i}}{2} \qquad ( 23 )$$

The initial acquisition phase of ADC 1054 may be configured to implement other gains based on configuration of switches 2204. For example, a gain of 1/16 may be implemented by controlling switches 2204 to connect only capacitor C₁ to Vᵢ during the initial acquisition phase of ADC 1054.

FIGS. 23A and 23B are schematic diagrams illustrating example stand alone modules 2300 and 2350 that may be switch into circuit by variable analog gain module 1052 of FIG. 10 to apply a gain to LS output signal 1326 and/or MS output signal 1328 of FIG. 13, in embodiments. Module 2300 represents one example switched capacitor circuit and module 2350 represents one example R-2R ladder circuit. Other switched capacitor circuits and/or R-2R ladder circuits may be used without departing from the scope hereof. For example, variable analog gain module 1052 may include multiple modules 2300 and/or 2350 that are switch in and out of circuit with LS output signal 1326 and/or MS output signal 1328 as needed.

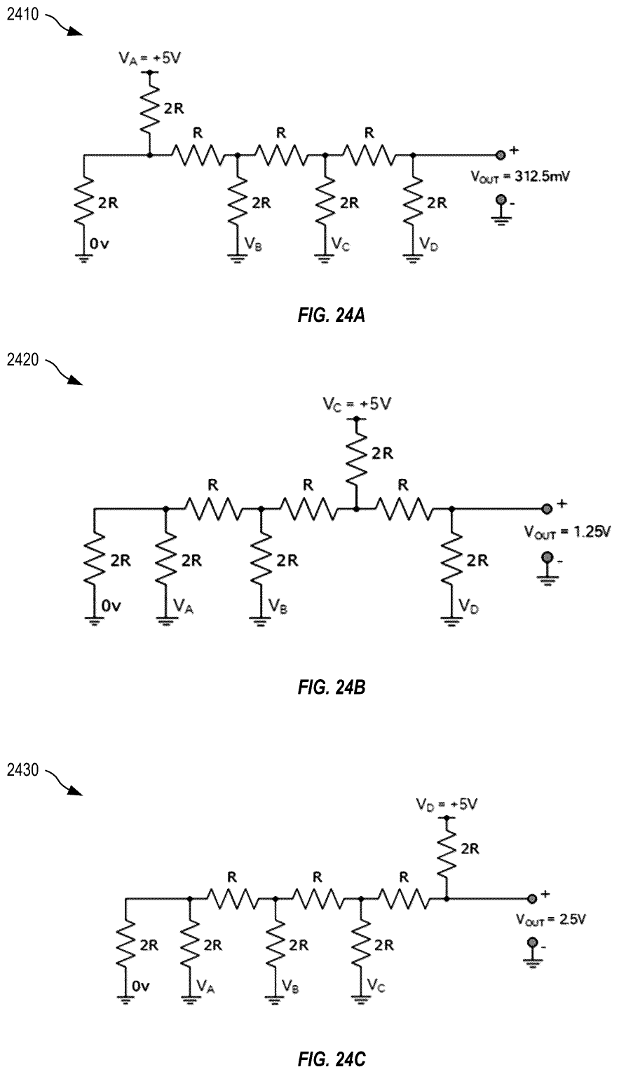

FIGS. 24A, 24B, and 24C are schematic diagrams illustrating three example circuits 2410, 2420, 2430, respectively, illustrating example operation of module 2350 of FIG. 23B, in embodiments. FIGS. 23B, 24A, 24B, and 24C are best viewed together with the following description. Circuit 2410 implements a gain defined by equation (24), circuit 2420 implements a gain defined by equation (25), and circuit 2430 implements a gain defined by equation (26).

$${V}_{out} = \frac{{V}_{i}}{16} \qquad ( 24 )$$

$${V}_{out} = \frac{{V}_{i}}{4} \qquad ( 25 )$$

$${V}_{out} = \frac{{V}_{i}}{2} \qquad ( 26 )$$

Particularly, control circuitry 1008 controls variable analog gain module 1052 to configure module 2350 as one of three example circuits 2410, three example circuits 2420, and three example circuits 2430 to implement corresponding gains of Vᵢ/16, Vᵢ/4, and Vᵢ/2 on LS adjusted signal 1127 MS adjusted signal 1129, LS adjusted signal 1327, and MS adjusted signal 1329 prior to capture by ADCs 1054. Accordingly, module 2350 may be controlled to implement bit truncation in the analog domain.

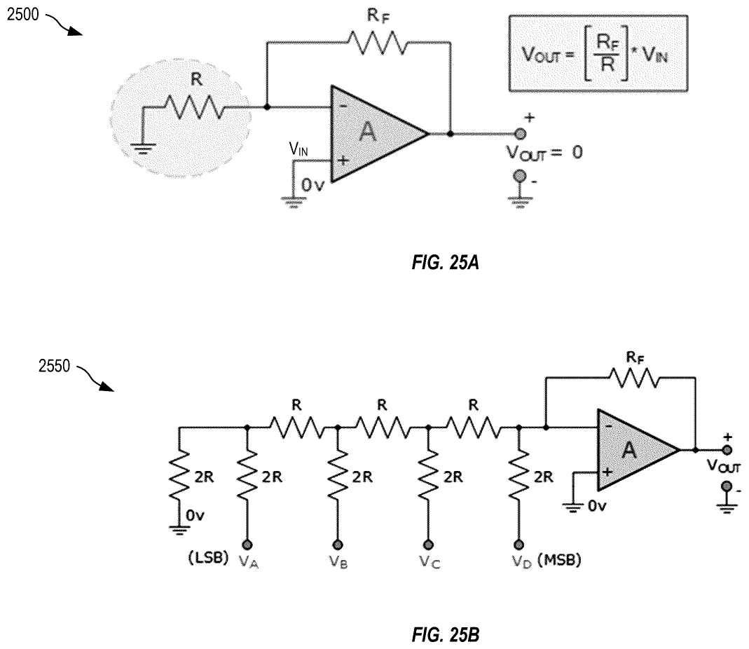

FIG. 25A is a schematic illustrating a conventional amplifier circuit 2500, in embodiments. FIG. 25B is a schematic illustrating one example R-2R DAC circuit 2550 used by ADC 1054 of FIG. 10, in embodiments. In this example, R DAC circuit 2550 is shown with a four-bit input represented by inputs V_{A}, V_{B}, V_{C}, and V_{D}, where, of the four-bit input value, input V_{A} is the LSB, and input V_{D} is the MSB. This circuit is used with resistive ladder circuits shown in FIGS. 24A-24C. This works as ADC. This is an alternative type of ADC.

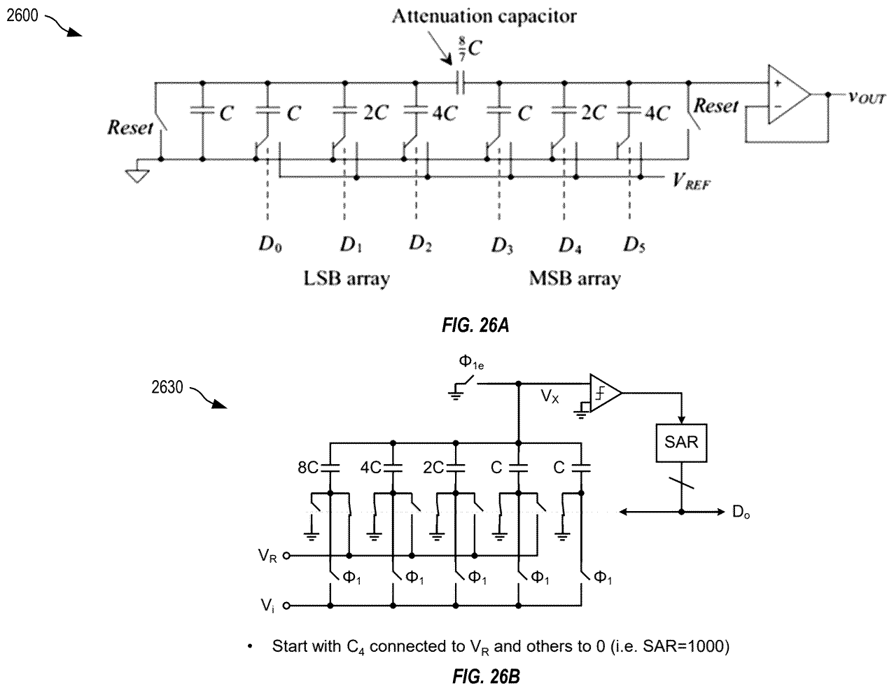

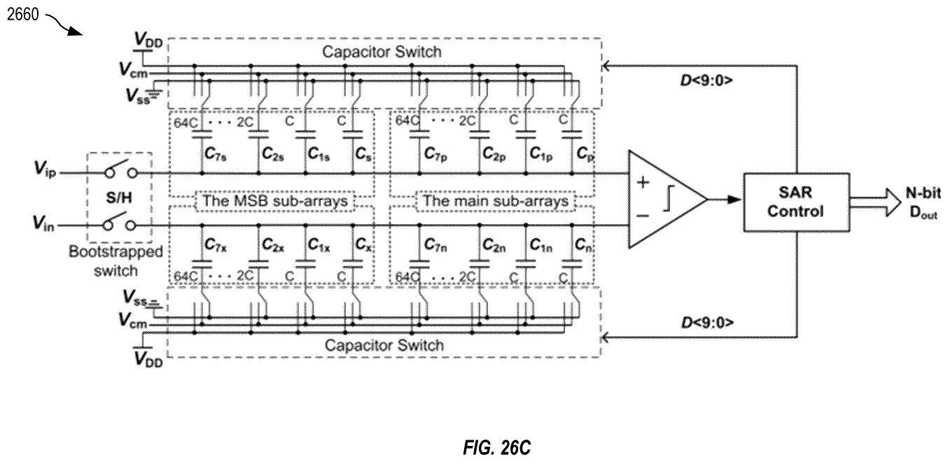

FIGS. 26A, 26B, and 26C are schematic diagrams illustrating example SAR ADCs 2600, 2630, and 2660, respectively, that may each represent ADC 1054 of FIG. 10, in embodiments. ADCs 2600, 2630, and 2660 illustrate example capacitor configurations that may be used to represent ADCs 1054.

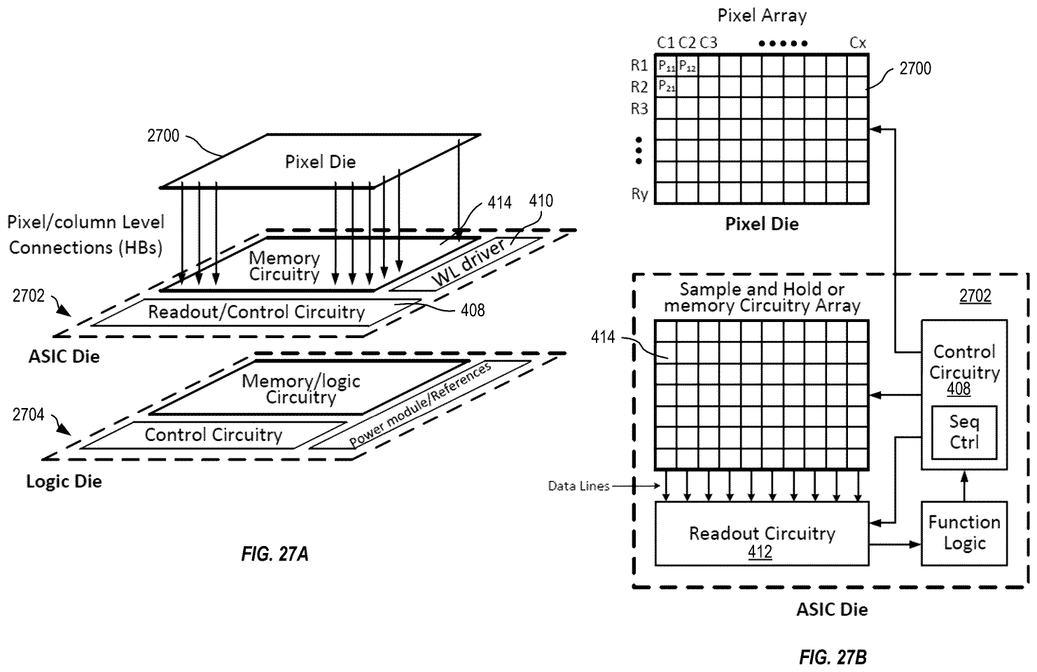

FIG. 27A is a schematic diagram illustrating one example integration of computational memory 400 of FIG. 4 with an image sensor 2700, in embodiments. FIG. 27B is a schematic diagram illustrating example functionality between image sensor 2700 and ASIC die 2702 of FIG. 27A, in embodiments. FIGS. 27A and 27B are best viewed together with the following description.

Computational memory 400 and image sensor 2700 (e.g., a pixel die) may be electrically coupled through wafer-to-wafer hybrid bonding (HB) connectors on an ASIC die 2702. ASIC die 2702 may couple with a logic die 2704. A readout/control circuitry (e.g., control circuitry 408, FIG. 4, control circuitry 1008, FIG. 10) controls operation of cross-bar array 414 to process images captured by image sensor 2700 through DNN 300. For example, DNN 300 may implement inference of images captured by image sensor 2700. As shown in FIG. 27B, control circuitry 408 controls input of data from image sensor 2700 into cross-bar array 414 based on a sequence controller. Output peripheral circuits 412 convert the output of cross-bar array 414 into data used by a function logic and/or further processing elements, such as by memory circuits of a logic die 2704. This architecture realizes AI functionality “in sensor” (e.g., configured as part of a sensor circuit). When the AI functionality is in sensor, the data being sent from image sensor 2700 to a host device may be reduced to only meta data. This significantly reduces a required data bandwidth and reduces computational work load on the host device.

Advantageously, by combining computational memory 400 with image sensor 2700, on-chip object classification or object identification may be implemented to detect one or more objects in the captured image based on a predefined set of objects stored in a memory (e.g., look up table) based on CNN output parameters.

### Cooperative ADC Shifting and Summing

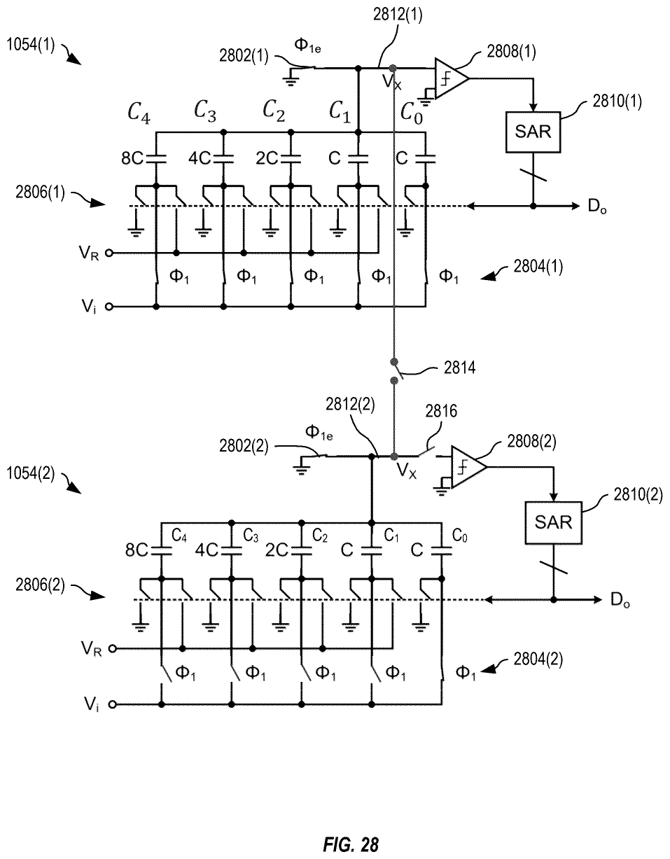

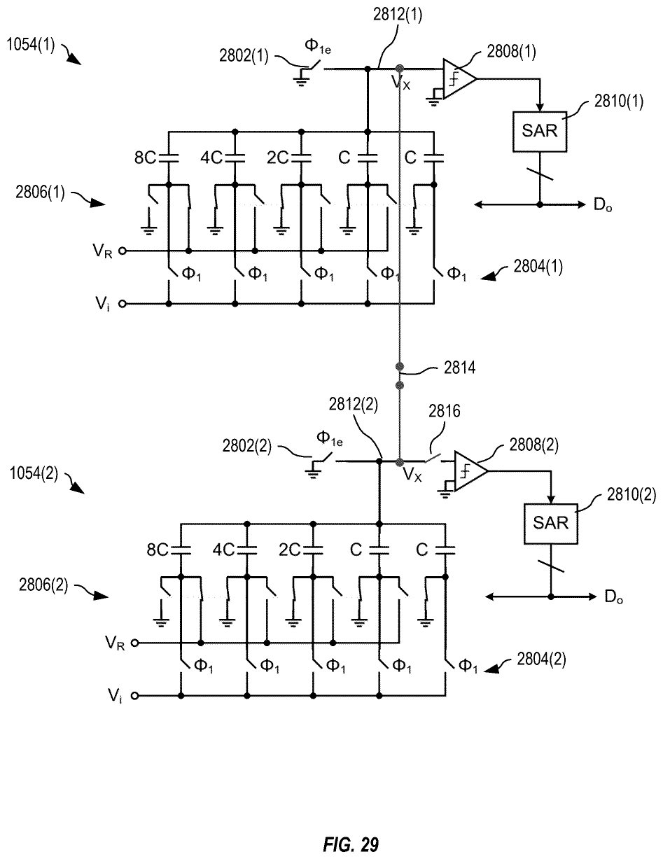

FIGS. 28 and 29 are schematic diagrams illustrating cooperation between two ADCs 1054(1) and 1054(2) to bit-shift and sum two analog values (e.g., LS output signal 1326 and MS output signal 1328) prior to conversion of the total to a digital value, in embodiment. In the following example, ADC 1054(1) is connected to MS output signal 1328 (e.g., column 422(1)) and ADC 1054(2) is connected to LS output signal 1326 (e.g., column 422(2)) of noise reduction 1300 of FIG. 13; however, ADC cooperation may equally apply to any pair of adjacent columns of computational memory 1000 that generate partial sums from splitting of the same digital weight. For example, ADC cooperation may also apply to columns 422(1) and 422(2) of noise reduction 1100 of FIG. 11 to apply a gain to LS output signal 1126 and then sum LS output signal 1126 and MS output signal 1128 to form resulting value 1120.

As shown in FIGS. 28 and 29, an input conductor 2812(1) of ADC 1054(1) is electrically coupled to an input conductor 2812(2) of ADC 1054(2) via a switch 2814. Switch 2814 is open during the first acquisition phase and input conductor 2812(2) is disconnected from comparator 2808(2) of ADC 1054(2) by a switch 2816.

Assuming the fifth cycle (e.g., j=4) of implementation 1700 of FIG. 17 for this example, control circuitry 1008 configures ADCs 1054(2) to apply a gain of V/16 to LS output signal 1326 and configures 1054(1) to apply a unity gain to MS output signal 1328. Control circuitry 1008 then configures ADC 1054(1) and 1054(2) as shown in FIG. 28 to capture MS output signal 1328 and LS output signal 1326, respectively. FIG. 28 shows an acquisition phase of ADCs 1054(1) and 1054(2) where switches 2802(1) and 2802(2) are closed, switches 2806(1), 2806(2), 2814, and 2816 are open. Capacitors C₀-C₄ of ADC 1054(1) are connected to Vᵢ (e.g., MS output signal 1328), capacitors C₀-C₁ of ADC 1054(2) are connected to Vᵢ (e.g., LS output signal 1326), but capacitors C₂-C₄ of ADC 1054(2) are not connected to Vᵢ. Accordingly, capacitors C₀-C₄ of ADC 1054(1) are charged from MS output signal 1328 and capacitors C₀-C₁ of ADC 1054(2) are charged from LS output signal 1326; however, capacitors C₂-C₄ of ADC 1054(2) remain uncharged. Accordingly, ADC 1054(2) applies a gain of V/16 to LS output signal 1326. FIG. 29 shows a subsequent conversion phase of ADCs 1054(1) and 1054(2) where switches 2802(1), 2802(2), 2804(1), 2804(2), and 2816 are opened, and switch 2814 is closed. SAR 2810(1) is then controlled to capture LS-MS summing 1716 for the current cycle. Particularly, LS partial sum 1314(4) is shifted right by four bits relative to MS partial sum 1316(4) prior to summing and conversion to generate a single summed value for MS summing 1706. During the conversion, SAR 2810(1) synchronized with SAR 2810(2) and both switches 2804(1) and 2804(2) are controlled. Operation of ADCs 1054(1) and 1054(2) in this embodiments is defined by equations (27) and (28).

$${V}_{i} C = ( {V}_{R} - {V}_{x} ) {C}_{4} - {V}_{x} ( {C}_{3} + {C}_{2} + {C}_{1} + {C}_{0} ) \qquad ( 27 )$$

$${V}_{x} = \frac{{V}_{R} \cdot 8 C - {V}_{i} \cdot C}{16 C} = \frac{{V}_{R}}{2} - \frac{{V}_{i}}{16} \qquad ( 28 )$$

FIG. 29 shows a second phase of cooperative operation of ADCs 1054(1) and 1054(2), where switches 2802(1), 2802(2), 2804(1), 2804(2), 2806(1), and 2806(2) are opened, and switch 2814 is closed. Switch 2816 remains open. Comparator 2808(1) and SAR 2810(1) of ADC 1054(1) then operate to determine a digital value corresponding to a sum of (a) LS output signal 1326 with a gain of 1/16 (e.g., a right shift of four-bits) and (b) MS output signal 1328. Comparator 2808(2) and SAR 2810(2) of ADC 1054(2) do not operate to capture a digital value in this configuration. Advantageously, truncation, bit-shifts, and summing are performed in the analog domain. This method may be implemented for more than two adjacent columns 422 of computational memory 1000.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A mixed analog/digital in-memory computing system with noise reduction, comprising:
a cross-bar array of analog cells for performing matrix vector multiplication, the cross-bar array having a plurality of input conductors for each row of the cross-bar array, and a plurality of output conductors for each column of the cross-bar array;
an input peripheral circuit for converting, for each row, an input activation (IA) value into a first IA analog signal driving the input conductor of the row;
an analog-to-digital conversion circuit for converting, for each column, an output signal carried by the output conductor of the column to a digital value;
a logic operation unit for multiplying, adding, and storing the digital values from the plurality of columns; and
control circuitry for controlling operation of the input peripheral circuit, the analog-to-digital conversion circuit, and the logic operation circuit to cause the cross-bar array to perform matrix vector multiplication by splitting the digital multiplier between multiple columns and combining digital values from the multiple columns to form a resulting value with reduced noise.

2. The mixed analog/digital in-memory computing system of claim 1, further comprising a variable gain module electrically coupled with the plurality of output conductors to apply at least two different gains to different ones of the output signals.

3. The mixed analog/digital in-memory computing system of claim 2, the variable gain module comprising at least one resistive ladder circuit or at least one switched capacitor circuit, the control circuitry configuring the variable gain module to implement the at least two different gains.

4. The mixed analog/digital in-memory computing system of claim 1, the input peripheral circuit comprising a plurality of word line digital-to-analog converters (DACs).

5. The mixed analog/digital in-memory computing system of claim 1, the analog-to-digital conversion circuit comprising a plurality of successive approximation register (SAR) analog-to-digital converters (ADC) for converting the output signal into the digital values.

6. The mixed analog/digital in-memory computing system of claim 5, the control circuitry controlling a digital-to-analog converter (DAC) of the SAR ADC to implement a gain on the output signal prior to the converting.

7. The mixed analog/digital in-memory computing system of claim 6, the control circuitry controlling the SAR ADC to capture fewer than a maximum number of bits of the SAR ADC.

8. The mixed analog/digital in-memory computing system of claim 5, the control circuitry controlling two of the plurality of SAR ADCs coupled with two of the output signals from adjacent columns of the cross-bar array to cooperate to capture a sum the two output signals after applying a gain to at least one of the two output signals.

9. The mixed analog/digital in-memory computing system of claim 1, the analog-to-digital conversion circuit comprising an analog-to-digital converter (ADC) with a resistive ladder circuit that is configurable by the controller to apply a gain to the output signal prior to the converting.

10. The mixed analog/digital in-memory computing system of claim 1, each of the analog cells comprising a memristor, whereby the cross-bar array operates in a current domain.

11. The mixed analog/digital in-memory computing system of claim 1, each of the analog cells comprising a dynamic random access memory, whereby the cross-bar array operates in a charge domain.

12. The mixed analog/digital in-memory computing system of claim 1, the cross-bar array, the input peripheral circuit, and the analog-to-digital conversion circuit being implemented on an ASIC die and the logic operation unit and the control circuitry being implemented on a logic die.

13. The mixed analog/digital in-memory computing system of claim 12, further comprising a pixel die implementing an image sensor communicatively coupled with the ASIC die to provide the IA value for each row, wherein the mixed analog/digital in-memory computing system performs inference on images captured by the image sensor.

14. The mixed analog/digital in-memory computing system of claim 1, the cross-bar array, the input peripheral circuit, the analog-to-digital conversion circuit, the logic operation unit and the control circuitry being implemented on an ASIC die.

15. The mixed analog/digital in-memory computing system of claim 14, further comprising a pixel die implementing an image sensor that communicatively couples with the ASIC die to provide the IA value or each row, wherein the mixed analog/digital in-memory computing system implements inference of images captured by the image sensor.

16. A noise reduction method for mixed in-memory computing implemented as a cross-bar array of analog cells having a plurality of columns and a plurality of rows, the method comprising:
splitting a digital multiplier into at least a most significant (MS) portion and a least significant (LS) portion, the LS portion being formed of Z LS bits of the digital multiplier;
for each row of the cross-bar array:
preloading an analog cell of a first column using a first analog signal representative of the MS portion;
preloading an analog cell of a second column using a second analog signal representative of the LS portion; and
driving an input conductor of the row with an analog input signal representing a multi-bit input activation (IA) value for the row;
generating an MS output signal from the first column;
generating an LS output signal from the second column; and
determining a digital resulting value based on the MS output signal and the LS output signal.

17. The noise reduction method of claim 16, wherein said preloading, said driving, and said generating are performed in an analog domain.

18. The noise reduction method of claim 17, wherein the cross-bar array of analog cells is implemented in a current-domain.

19. The noise reduction method of claim 17, wherein the cross-bar array of analog cells is implemented in a charge-domain technology.

20. The noise reduction method of claim 16, said determining further comprising:
capturing the MS output signal as a digital MS partial sum;
capturing the LS output signal as a digital LS partial sum;
truncating a first number of LS-bits of the MS partial sum;
truncating a second number of LS-bits of the LS partial sum, wherein the second number is greater than the first number by L; and
summing the MS partial sum and the LS partial sum to form the digital resulting value.

21. The noise reduction method of claim 20, wherein said truncating and said summing are performed in a digital domain, and wherein said truncating is implemented by right-shifting.

22. The noise reduction method of claim 16, said determining further comprising:
applying a first gain to the MS output signal to form an MS adjusted signal that is smaller than the MS output signal;
applying a second gain to the LS output signal to form an LS adjusted signal that is smaller than the LS output signal, wherein the second gain is a factor of 2^{L} less than the first gain;
capturing the MS adjusted signal as a digital MS partial sum;
capturing the LS adjusted signal as a digital LS partial sum; and
summing the MS partial sum and the LS partial sum to form the digital resulting value.

23. The noise reduction method of claim 22, wherein said applying the first gain and applying the second gain perform truncation of the MS output signal and the LS output signal and are implemented in an analog domain, and wherein said summing is implemented in a digital domain.

24. The noise reduction method of claim 22, wherein said applying the first gain and applying the second gain are implemented by one of a resistive ladder circuit and a switched capacitor circuit.

25. The noise reduction method of claim 16, said determining further comprising:
applying a first gain to the MS output signal to form an MS adjusted signal that is smaller than the MS output signal;
applying a second gain to the LS output signal to form an LS adjusted signal that is smaller than the LS output signal, wherein the second gain is a factor of 2^{L} less than the first gain;
summing the MS adjusted signal and the LS adjusted signal to form as a digital MS partial sum;
capturing the LS adjusted signal as a digital LS partial sum; and
summing the MS partial sum and the LS partial sum to form the digital resulting value.

26. The noise reduction method of claim 25, wherein said applying the first gain and applying the second gain perform truncation of the MS output signal and the LS output signal and are implemented in an analog domain, and wherein said summing is implemented in a digital domain.

27. The noise reduction method of claim 16, wherein each row of analog cells is connected to one of a plurality of input conductors and each column of analog cells is connected to one of a plurality of output conductors, the cross-bar array performing matrix vector multiplication concurrently on a plurality of multi-bit input activation (IA) values to provide a partial sum for each column.

28. The noise reduction method of claim 16, said splitting the digital multiplier comprising splitting the digital multiplier into the MS portion, the LS portion, and a greatest-significant (GS) portion, said noise reduction method further comprising:
for each row of the cross-bar array, preloading an analog cell of a third column of the cross-bar array using a third analog signal representative of the GS portion;
generating an GS output signal from the third column; and
determining the digital resulting value based on the GS output signal, the MS output signal, and the LS output signal.

29. The noise reduction method of claim 16, the IA signal being generated by a digital-to-analog converter from a multi-bit IA value.

30. A noise reduction method for mixed in-memory computing implemented as a cross-bar array of analog cells having a plurality of columns and a plurality of rows, comprising:
splitting a digital multiplier into at least a most significant (MS) portion and a least significant (LS) portion, the LS portion being formed of L LS bits of the digital multiplier;
for each row of the cross-bar array:
preloading an analog cell of a first column using a first analog signal representative of the MS portion;
preloading an analog cell of a second column using a second analog signal representative of the LS portion;
slicing a multi-bit input activation (IA) value for the row into IA bits, where i is a bit position of the IA bit;
for each IA bit[i]:
driving an input conductor of the row with a first reference voltage when the IA bit is zero and driving the input conductor with a second reference voltage when the IA bit is one;
generating an MS output signal from the first column; and
generating an LS output signal from the second column; and
determining a digital resulting value based on both the MS output signal and the LS output signal for each IA bit[i].

31. The noise reduction method of claim 30, wherein said preloading, said driving, and said generating are performed in an analog domain.

32. The noise reduction method of claim 31, wherein the cross-bar array of analog cells is implemented in a current-domain.

33. The noise reduction method of claim 31, wherein the cross-bar array of analog cells is implemented in a charge-domain technology.

34. The noise reduction method of claim 30, said determining further comprising:
capturing the MS output signal as a digital MS partial sum for each IA bit[i];
capturing the LS output signal as a digital LS partial sum for each IA bit[i];
truncating a first number of LS-bits of each MS partial sum;
truncating a second number of LS-bits of each LS partial sum, wherein the second number is greater than the first number by L; and
summing the MS partial sums and the LS partial sums to form the digital resulting value.

35. The noise reduction method of claim 34, wherein said truncating and said summing are performed in a digital domain, and wherein said truncating is implemented by right-shifting.

36. The noise reduction method of claim 30, said determining further comprising:
applying first gains to the MS output signals to form MS adjusted signals that are smaller than the corresponding MS output signal;
applying second gains to the LS output signals to form LS adjusted signals that are smaller than the corresponding LS output signal, wherein the second gain is a factor of 2^{L} less than the corresponding first gain;
capturing the MS adjusted signals as digital MS partial sums;
capturing the LS adjusted signals as digital LS partial sums; and
summing the MS partial sums and the LS partial sums to form the digital resulting value.

37. The noise reduction method of claim 36, wherein said applying the first gains and said applying the second gains perform truncation of the MS output signals and the LS output signals and are implemented in an analog domain, and wherein said summing is implemented in a digital domain.

38. The noise reduction method of claim 36, wherein said applying the first gains and said applying the second gains are implemented by one of a resistive ladder circuit and a switched capacitor circuit.

39. The noise reduction method of claim 30, said determining further comprising:
applying first gains to the MS output signals to form MS adjusted signals that are each smaller than the corresponding MS output signal;
applying second gains to the LS output signals to form LS adjusted signals that are smaller than the corresponding LS output signal, wherein each second gain is a factor of 2^{L} less than the corresponding first gain;
summing the MS adjusted signal and the LS adjusted signal to form as a digital MS partial sum;
capturing the LS adjusted signal as a digital LS partial sum; and
summing the MS partial sum and the LS partial sum to form the digital resulting value.

40. The noise reduction method of claim 39, wherein said applying the first gains and said applying the second gains perform truncation of the MS output signals and the LS output signals and are implemented in an analog domain, and wherein said summing is implemented in a digital domain.
